(19) United States
(12) Patent Application Publication
(10) Pub. No.: US 2010/0073927 A1
(43) Pub. Date: Mar. 25, 2010

(54) Lens for Solid-State Light-Emitting Device

(76) Inventors: Ian Lewin, Scottsdale, AZ (US); John K. O'Farrell, Cave Creek, AZ (US)

Correspondence Address: LAW OFFICES OF DOUGLAS W. RUDY, LLC, 12101 E. Wethersfield Dr., Scottsdale, AZ, 85259, US

(21) Appl. No.: 12/234,681

(22) Filed: Sep. 21, 2008

(51) Int. Cl. F21V 5/04; G02B 13/18

(52) U.S. Cl. 362/240; 359/709; 362/311.01

(57) ABSTRACT

A lens is provided for use with a solid-state light-emitting device, typically a light-emitting diode. The lens may be used in luminaries for roadway lighting and other applications. In one embodiment the lens includes a conical structure proximate the light-emitting source of the light-emitting device.

### BACKGROUND OF THE INVENTION

1. Field of the Invention

This invention is related to a high performance lens for use in combination with a solid-state light-emitting device, typically a light-emitting diode (“LED”) and to the optics of the lenses of solid-state light-emitting devices used in luminaries for roadway lighting and other applications where light delivery is selectively and passively accomplished.

In one embodiment of the invention the lens for use with a solid-state light-emitting device includes an upstanding conical structure generally directly above the light-emitting source of the light-emitting device.

2. Description of the State of the Art

It is increasingly common to adopt new light sources for use in all types of lighting situations. Incandescent lamps that have been widely used in the commercial and residential lighting situations are being replaced by compact fluorescent lamps as the compact fluorescent lamps are more energy efficient than the lamps they replace and can put out much more light per watt than the incandescent lamps.

In the municipal and commercial lighting arena, and particularly luminaires for roadway illumination, high intensity discharge lamps such as high-pressure sodium vapor lamps, mercury vapor lamps, metal halide lamps and low-pressure sodium lamps comprise the majority of installed lighting systems. For instance, municipal streetlights, usually with a single lamp placed on a pole, are almost uniformly high-pressure sodium lamps. Spacing between poles is usually longer than the height of the luminaires carried on the poles. For instance, in roadway lighting luminaires the spacing between poles is four to six times the mounted height of the luminaire.

As the spacing between luminaires on a roadway is significant each luminaire is required to light a large area, normally an area much longer than the width of the light distribution pattern. For instance, the light distribution pattern for lighting a roadway or street could be in the general shape of a rectangle of, for example, twenty-five feet wide by one hundred fifty feet long.

It is becoming important to produce lighting solutions that are much more efficient than current lighting offerings. The invention disclosed herein is a significant improvement over currently installed lighting systems and provides a viable and cost effective alternative to current lighting system designs that rely on light-emitting diodes in high lumen delivery systems.

Widely used high intensity discharge (“HID”) street and area lighting systems create an undesirable pool of light under each HID luminaire. This is not useful and is waste of energy. Another disadvantage of HID systems is light distribution management. With the inefficient light distribution of light from HID systems it is necessary to space light poles such that there is enough light between the poles. Pole spacing is a major cost factor in street and area lighting systems. One advantage of the light-emitting diode-based systems presented herein is that the distance between adjacent poles can be greater than is usual with a comparable light output HID system.

A serious negative to the use of high intensity discharge lamps for street lighting is the amount of light pollution that is emitted from most street lighting luminaires. Another consideration of outdoor lighting systems is to create lighting that is reasonably uniform when measured in terms of illuminance (footcandles or lux) falling at various points on the ground to be lighted. Guidelines for the maximum allowable ratio of the average to minimum illuminance on a roadway is set forth in publication ANSI/IESNA RP-8-00 prepared by the Standard Practice Subcommittee of the IESNA Roadway Lighting Committee, titled American National Standard Practice for Roadway Lighting.

Optical control for luminaires relying on HID lamps is achieved by use of components comprised of refractors and/or reflectors. Most of these systems rely on capturing and directionally controlling light from the elongated discharge tube of the HID lamp.

One application of the invention disclosed herein is in the use of solid-state light-emitting devices such as, but not limited to, LED's in street and area lighting. A program initiated by municipalities to replace the HID lamps with banks of LED's, which LED's are approaching luminous efficacy of the high intensity lamps. It is expected that LED will soon exceed some HID lamps. Such improvement in LED efficacy will yield not only significant energy savings but also longer service life of the LED based luminaires as compared to HID lamps. Furthermore, using the techniques disclosed herein produce a better distribution of light emanating from the luminaire. There is a movement in the outdoor lighting industry to design future roadway lighting systems, where performance specifications will be based on the minimum illuminance produced at any point on the pavement. This may replace the specifications directed solely to what the average light delivery over all points may be, i.e. the average light distribution based specification. Present forms of specifications for roadway lighting require a certain average light level. Such average light level specifications encourage the use of luminaires that produce a large, wasteful pool of high illuminance under the fixtures. LED luminaires of the type described in this specification can largely eliminate this wasteful pool of light while increasing the light level at the points distant from the luminaires where low light levels are historically found in HID based luminaire system. Thus LED systems can meet the more rigid and contemporary specifications based on minimum lighting levels with reduced energy consumption through the elimination of the wasteful pools of light beneath every HID based fixture.

As an interesting contrast to roadway lighting, lighting specifications for parking areas already use the “minimum at any point” approach.

Another advantage of LED's is that LED based luminaires also run cooler than HID lamp systems. LED based systems are also more vibration resistant and may have smaller overall packaging size than the HID lamp based systems. LED based luminaires are now in their infancy, but are at least practical for general outdoor lighting and LED street lights are being developed as they are expected to become extremely energy efficient. However the unique light distribution requirements of street lighting systems is still being refined.

LED based street lighting luminaires can last anywhere from five to twelve years without significant maintenance. This longevity of the LED based streetlights may more than offset the initial purchase price of and LED luminaire. LED based street lighting systems can focus the light better onto the ground, cutting down on light trespass. One other, somewhat subjective, advantage of LED's based streetlights is that the glow of an LED streetlight is considered pleasant by many observers.

A further advantage of LED-based street lighting systems is that the light produced in an LED-based system is a white light as opposed to the yellow light given off by high-pressure sodium lamps. This is advantageous as white light has been shown to produce higher visibility under some conditions as compared to high-pressure sodium lamps.

A current deficiency in LED streetlights is the difficulty of controlling the distribution of the light being emitted. As a single LED is of small wattage, typically three watts or less. Outdoor lighting luminaires employ numerous LED's. Each of these LED's can be mounted to direct its light output to a specific location however this is difficult and expensive as each LED would have to be mounted and located individually and individually aimed. In LED based luminaires a bank of LEDs will be mounted on a board. Usually the board is a printed circuit board. There will be numerous LED's on each board depending on the amount of light to be generated by the device. In the past LED's were furnished from LED manufacturers to consuming industries with 5 mm dome shaped lenses suitable for many purposes. Now many other dome dimensions, shapes and LED to lens relationship configurations are available. The boards of ganged LED's are arranged in a flat configuration or in a curved configuration in the host luminaire housing. The lenses of each LED are generally of the same configuration and will not normally, that is without a focusing lens, project a pattern of light appropriate for lighting a street.

A manufacturer of LED-based lighting systems, such as, but not limited to, luminaires for street lighting, parking structure lighting, room lighting, vehicle lighting, traffic control signals, and specialty lighting systems, or for other situations requiring a directional light output from the LED, may apply a lens over the factory supplied dome shaped lens to get the distribution of light desired in a particular light distribution system or distribution requirement. Alternatively, the LED manufacturer may supply the LED with a lens shape, usually fitted over a standard LED dome, to deliver light in a predetermined delivery pattern.

One LED with a shaped lens, shaped in the manufacturing process of the complete LED, is set forth in U.S. Patent Application Publication No. 2007/0217195 to Chen. This patent publication is herein incorporated by reference in its entirety. In Chen the lens is formed over a light-emitting component and the lens is finished as a single unitary component. The lens of Chen's structure has a center section that is significantly different from the lens disclosed in this specification. In Chen the center section of the lens includes a reflectively coated air cone that disrupts the emitted light pattern of the lens cap and creates a zone of little, if any, light output the air cone section. Chen's lens is designed to emit light perpendicular from the normal axis of the light-emitting component rather than more parallel to the normal axis or in a nadir of the LED. The reflective material coating the inverted air cone in the Chen lens component of the complete LED device results in complete internal reflection and prevents light emission from projecting out from the lens in a direction substantially parallel with the vertical axis of the LED. The lenses, several embodiments including, set forth in this disclosure do not have a central inwardly directed cone. The configuration shown in Chen would not have the scope of utility, particularly in roadway illumination, as the device set forth herein.

In another device the LED supplied from a manufacturer is augmented with a lens on top of the dome shaped lens of a “stock” LED. For instance, see the configuration set forth in U.S. Patent Application Publication No. 2007/0201295 to Holder, et al. This patent publication is herein incorporated by reference in its entirety.

In addition to the printed publications above there are numerous patents directed to lenses of LED's being formed to direct the light output in a particular pattern. Many of these patents concern directing the light perpendicular to the major axis of the light source, the LED light source, using various lens configurations. For instance see: U.S. Pat. No. 6,598,998 for Side Emitting Light-emitting Device of West, et al; U.S. Pat. No. 6,607,286 for Lens and Lens Cap with Sawtooth Portion for Light-emitting Diode of West, et al; U.S. Pat. No. 7,083,313 for Side-Emitting Collimator of Smith; U.S. Pat. No. 7,142,769 for Illumination Package of Hsieh, et al.; U.S. Pat. No. 7,153,002 for Lens for LED Light Sources of Kim, et al.; Patent Publication US 2006/0291201 for Side-Emitting Collimator of Smith; and Patent Publication US 2007/0195534 to Ha, et al. As evidenced from the plethora of patents and publications concerned with directing light perpendicular to the major axis of an LED, it clear that LED lenses for the distribution of light in a pattern useful in roadway lighting are a narrow application of LED lens technology. All of the patents and publications mentioned in this paragraph are herein incorporated by reference in their entireties.

Of further interest are several patents and publications that pertain to lens configurations designed to distribute light in a specific pattern. These include: U.S. Pat. No. 7,181,378 for Compact Folded-Optics Illumination Lens to Benetez, et al.; Publication No. US 2006/0126343 for LED Light Source to Hsieh, et al.; Publication No. US 2006/004806 for Light-emitting Diode System Packages by Abramov, et al.; and Publication No. US 2007/0159847 for Collimating Lens for Led Lamp of Li. Each of the foregoing publications and the patent are hereby incorporated by reference in their entireties.

### SUMMARY OF THE INVENTION

The design of a lens for solid-state light-emitting devices, such as, but not limited to, LED's, presents several significant problems. A first concern is the light distribution on the lighted pavement close to or directly beneath the luminaire. In contemporary HID street and area lighting systems the area directly below the HID lamp is usually lighted at too high a level, forming a pool of excess light, which is not useful and a wasteful allocation of available light energy. Even a light of low intensity mounted on a conventional light pole aimed downwards will create a relatively high level of illuminance as the distance from the luminaire to the ground is relatively small.

Another problem presented to the lighting designer in the design of street lighting systems is to design a system to project an adequate level of light at points distant from the luminaire as the light intensity required to produce a given level of illuminance is very much greater, due to the inverse square law related to illuminance drop off, than for points close to or directly beneath the luminaire. This is exacerbated as light rays traveling to distant points are also incident upon the generally horizontal illuminated surface at a relatively large angle as measured from a perpendicular direction to the surface, and the illuminance is reduced in proportion to the cosine of this angle. Most LED's emit light in a forward direction, that is the emitted light is generally aligned with the major vertical axis of the LED, such that the light output is centered around an axis that coincides with the physical axis of the LED. HID lamps produce a generally toroidal intensity distribution and thus the optical systems for distributing light from the high intensity lamps are not helpful as optical systems for distribution of light generated by LED based systems. Thus in order to apply LED based systems to outdoor lighting situations, such as, but not limited to roadway or street lighting, new configurations of optics are required to provide a reduction in intensity in directions at or close to straight down from the LED based luminaire and the necessary increase in intensity towards distant ground locations.

In responding to the problems mentioned above it is advantageous that optical designs used to control light emission and distribution from LED's are flexible, as will be possible with the lens design set forth in this disclosure, so as to allow adjustment of the ground lighting pattern to meet the geometry of the area to be illuminated, the luminaire placement and layout.

LED's that emit light in a generally forward direction centered around the axis of the LED may be aimed downward to provide maximum intensity in the nadir direction. An array of such LED's mounted on a horizontal surface such as a metal plate or a printed circuit board, can thus create a high intensity of light in a nadir direction. However such a light distribution arrangement does not meet the requirements commonly encountered in designing an outdoor lighting system. The invention presented herein however overcomes this problem by presenting a single LED, or an array of LED's, arranged with a lens element proximate to or vertically adjacent with each LED to modify the generally downward light ray emission. This lens element splits and redirects the light into desired directions using a simple and inexpensive lens design that maintains low lens profiles resulting in a compact LED and lens combination. The spacing between the LED array and the lens prism array is relatively small helping to achieve the desired low profile of the LED based luminaire.

The advantages of the LED lighting system presented here are accomplished by providing a lens in cooperation with an LED light source where the lens has several sections. One section of the lens is a bridging section or flat section and rays will pass through this lens section with little or no deviation. A second section of the lens is a conically shaped light-transmitting element, which in some embodiments could be a generally Vee-shaped (in cross-section) splitting prism usually carried on and extending from the bridging section or flat section of the lens in the nadir. This element, the conically shaped light-transmitting element may be directly beneath, generally proximate to, the source of light from the LED light source, when the LED is pointed downwardly as it may be in a street lighting embodiment. Light rays from the LED striking the internal surface of the conically shaped light-transmitting element or prism of the lens undergo total internal reflection and are emitted through the side surface of the conically shaped light-transmitting element at a highly elevated angle, generally in the range of, but not limited to, fifty degrees to eighty degrees from nadir (LED pointed downwardly). Such reflected and refracted rays travel outwardly from nadir so as to strike the ground at locations distant from the luminaire.

In selecting the appropriate apex angle of the conically shaped light-transmitting element, lateral beams are produced to present high intensity at the desired angles. Additionally, the generally downwardly projecting rays emitted from the LED's when the system of LED's and lenses is directed downwardly, are intercepted and redirected and diverted from their downward path, to achieve the desired reduction in intensity toward the area close to or directly under the luminaire.

In one embodiment of the invention a top surface prism is provided. This causes refraction in a forward direction before light is directed laterally by the bottom surface of the prism. This embodiment may be desirable where luminaires are positioned at the side of an area to be illuminated, and will move the entire light pattern in a generally forward direction.

Another embodiment of the invention uses a conically shaped light-transmitting element or prism surface that is not flat. Curvature of either the upper or the lower surface areas of the prism allows modification of the intensity distribution so as to tailor the light emission pattern to suit the size and shape of the area being lighted.

In other embodiments variations of prism angle can be used to compensate for an upward tilting of the LED mounting surface as is encountered in some luminaire designs. Such upward tilting elevates the light rays but with the proper selection of the conically shaped light-transmitting element or prism angles this elevation, if deemed necessary for a particular installation, can be increased or decreased by refraction.

One advantage in using LED based luminaires for street lighting is that the LED street light can be made smaller than HID units. This allows for a smaller luminaire housing that will be less susceptible to wind loading and thus a reduction in pole strength and its associated cost is possible.

A further problem that is addressed by lighting designers is the control of glare. Glare perceived by an observer is caused by light rays emitted from a luminaire at angles just below the horizontal. Such rays provide little ground illumination but create high luminaire luminance from a viewer's perspective. Thus it is an object of the invention to reduce the light distribution causing glare in such near horizontal directions. This may be accomplished by having a “fast run-back” above the beam, that is, a reduction in light intensity for angles above the maximum intensity should be rapid with respect to the angle.

Another object of this invention is to provide a system of optical control that efficiently allows the collection of most of the light emitted from an LED or from an array of LED's.

It is another object of this invention to provide a system of optical control that creates low emission of light intensity toward ground areas that are close to the luminaire containing an array of LED's.

It is another object of this invention to provide a system of optical control that creates good illumination of areas that are within the area to be lighted by an LED luminaire but are distant from the LED based luminaire.

It is another object of this invention to provide a system of optical control that tunes and tailors the pattern of light incident on the ground in the vicinity of the LED based luminaire such that relatively uniform illuminance is created over the entire area desired to be illuminated by an LED luminaire.

It is another object of this invention to include allowing the placement of an array of LED's on a surface that can be simply formed.

It is another object of this invention to provide a system of optical control that has a flexibility in design allowing for a desired pattern of light to be generated by or for various shapes and sizes of luminaire housings.

It is another object of this invention to provide a compact luminaire that has a low profile and is otherwise of less bulk and mass than luminaires for use with HID lamps.

It is yet a further object to provide an LED based luminaire emitting a low level of glare.

The preferred embodiments of the invention presented here are described below in the drawings and detailed specification. Unless specifically noted, it is intended that the words and phrases in the specification and the claims be given the plain, ordinary and accustomed meaning to those of ordinary skill in the applicable arts. If any other special meaning is intended for any word or phrase, the specification will clearly state and define the special meaning. Likewise, if a noun, term or phrase is intended to be further characterized or specified, such will include adjectives, descriptive terms or other modifiers in accordance with the normal precepts of English grammar. Absent use of such adjectives, descriptive terms or modifiers, it is the intent the nouns, terms or phrases be given their plain and ordinary English meaning to those skilled in the applicable arts.

Further, the use of the words “function,” “means” or “step” in the Specification is not intended to indicate a desire to invoke the special provisions of 35 U.S.C. 112, Paragraph 6, to define the invention. To the contrary, if the provisions of 35 U.S.C. 112, Paragraph 6 are sought to be invoked to define the inventions, the claims will specifically state the phrases “means for” or “step for,” and will also clearly recite a function, without also reciting in such phrases any structure, material or act in support of the function. Thus, even when the claims recite a “means for” or “step for” performing a defined function, if the claims also recite any structure, material or acts in support of that means or step, or that perform the function, then the intention is not to invoke the provisions of 35 U.S.C. 112, Paragraph 6. Moreover, even if the provisions of 35 U.S.C. 112, Paragraph 6 are invoked to define the claimed inventions, it is intended that the inventions not be limited only to the specific structure, material or acts that are described in the preferred embodiments, but in addition, include any and all structures, materials or acts that perform the claimed function as described in alternative embodiments, or that are well known present or later-developed, equivalent structures, material or acts for performing the claimed function.

### BRIEF DESCRIPTIONS OF THE DRAWINGS

A more complete understanding of the present invention may be derived by referring to the detailed description when considered in connection with the following illustrative figures. In the figures, like reference numbers refer to like elements or acts throughout the figures.

FIG. 1 is a representation of a line of poles having luminaries mounted thereon in an elevation view.

FIG. 2 is a plan view of the poles and luminaires of FIG. 1.

FIG. 3 is a polar graph of luminous intensity of a typical HID lamp outdoor lighting luminaire.

FIG. 4 is a pictorial representation of the forward distribution of light from a common type of LED.

FIG. 5 is a polar intensity graph for three different LED configurations.

FIG. 6 is a pictorial representation of a prior art LED and lens combination.

FIG. 7 is a pictorial representation of another prior art LED and lens combination.

FIG. 8 is a pictorial representation of a prior art luminaire having LED's aimed at various angles.

FIG. 9 is a side elevation view of a prior art lens positioned on an LED for directing the forward light from the LED at high angles from a major axis using a Vee-shaped prism.

FIG. 10 is a side elevation view of the prior art lens of FIG. 9 showing the curved sides for directing the forward light from an LED at high angles from a major axis by use of a Vee-shaped prism.

FIG. 11 is a representation in chart form (a cross sectional view without cross hatching for the sake of clarity) of a portion of the light from an LED source traveling through one embodiment of the invention.

FIG. 12 is a representation in chart form (a cross sectional view without cross hatching for the sake of clarity) of a portion of the light from an LED source traveling through another embodiment of the invention where the body of the conical splitting prism is curved.

FIG. 13 is a representation in chart form (a cross sectional view without cross hatching for the sake of clarity) of a portion of the light from an LED source traveling through another embodiment of the invention where the body of the conical splitting prism is made up of a series of facets.

FIG. 14 is a polar intensity graph for a splitting prism having straight sides and for a splitting prism having curved sides.

FIG. 15 is a representation in chart form (a cross sectional view without cross hatching for the sake of clarity) of a portion of the light from an LED source traveling through a first conical prism (solid lines) and with a representation of light from an LED source traveling through a prism with an increased apex angle (dashed lines) relative to the first prism.

FIG. 16 is a representation in chart form (a cross sectional view without cross hatching for the sake of clarity) of a portion of the light from an LED in one location traveling through a prism a first distance away from the LED (solid line) and with a dashed line representation of light from an LED source traveling through the same prism spaced a second distance away from the LED.

FIG. 17 is a representation in chart form (a cross sectional view without cross hatching for the sake of clarity) of a light path through a planar sheet of light transmissive material located between the LED source and the splitting prism.

FIG. 18 is a representation in chart form (a cross sectional view without cross hatching for the sake of clarity) of light paths through a refracting ring structure located between the LED source and the splitting prism.

FIG. 19 is a representation in chart form of light paths through a generally U-shaped prismatic structure (in cross section, with cross hatching of the structure omitted for clarity) proximate a splitting prism.

FIG. 20 is a representation in chart form of light paths through a generally U-shaped prismatic structure (in cross section, with cross hatching of the structure omitted for clarity) proximate a splitting prism where the interior wall surface of the U-shaped prismatic structure is modified from the structure shown in FIG. 19.

FIG. 21 is a representation in chart form of light paths through a generally U-shaped prismatic structure (in cross section, with cross hatching of the structure omitted for clarity) proximate a splitting prism where the interior wall surface of the U-shaped prismatic structure is modified from the structure shown in FIG. 20 to lower the angle of the emitted rays.

FIG. 22 is a pictorial representation (a cross sectional view without cross hatching for the sake of clarity) of a conical splitting prism having a convex truncated portion proximate the apex of the prism allowing direct refraction in the truncated portion.

FIG. 23 is a pictorial representation (a cross sectional view without cross hatching for the sake of clarity) of a conical splitting prism having a concave truncated portion proximate the apex of the prism allowing direct refraction in the truncated portion.

FIG. 24 is polar graph of light intensity distribution of a lens of the invention assuming axial symmetry.

FIG. 25 is polar graph of light intensity distribution of a lens of the invention of not assuming axial symmetry.

FIG. 26 is a representation in chart form of a light path through a generally U-shaped prismatic structure (in cross section, with cross hatching of the structure omitted for clarity).

FIG. 27 is a representation in chart form of light paths through a generally U-shaped prismatic structure (in cross section, with cross hatching of the structure omitted for clarity) where the interior wall surface of the U-shaped prismatic structure is modified from the structure shown in FIG. 26.

FIG. 28 is a representation in chart form of light paths through a generally U-shaped prismatic structure (in cross section, with cross hatching of the structure omitted for clarity) where the interior wall surface of the U-shaped prismatic structure is modified from the structure shown in FIG. 27 to lower the angle of the emitted rays.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention. It should be noted that there are many different and alternative configurations, devices and technologies to which the disclosed inventions may be applied. The full scope of the inventions is not limited to the examples that are described below.

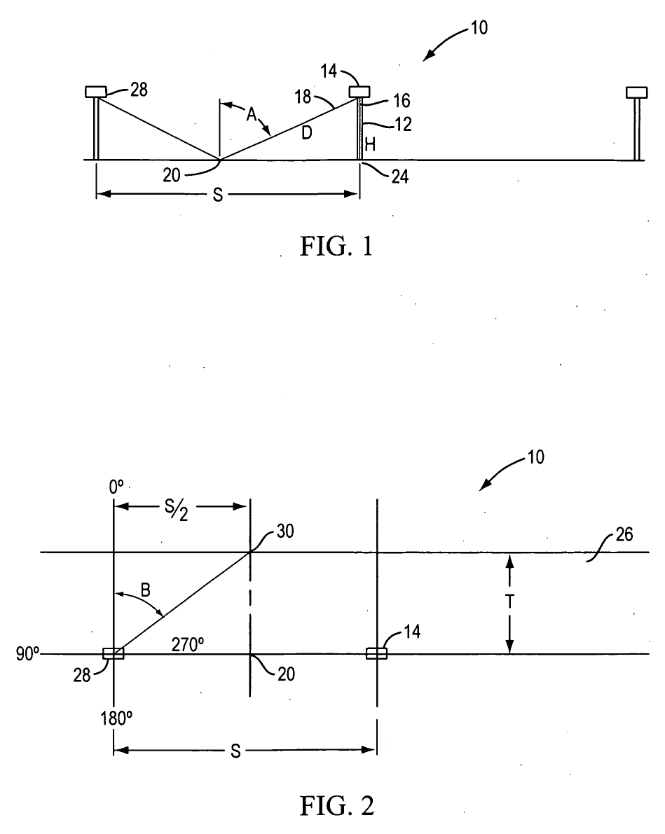

FIG. 1 in combination with FIG. 2, is a representation of a group of three light poles, generally 10, that show one environment, an outdoor lighting system such as but not limited to, a parking lot, or street lighting system. Each of the three light poles, one shown as 12, have a luminaire 14 attached near or at the top of the pole 12 as is usual in an outdoor lighting system. In FIG. 1 the poles are shown in an elevation view of a vertical plane that intersects the center point of the light source of each of the three luminaires. In this FIG. 1 a light ray 16 is emitted from the light source 14 in a nadir direction and travels a distance “H” to the ground. A second light ray 18 is emitted from the same source to a point midway between an adjacent pole and travels a distance “D” before striking the ground. Light ray 16 is incident perpendicularly, while light ray 18 is incident at an angle “A” to the perpendicular. The illuminance at point 24 created by light ray 16, E24, where I₁₆, is the intensity of light ray 16, is:

$${E}_{24} = \frac{{I}_{16}}{{H}^{2}}$$

The illuminance at point 20 created by ray 18, E20, where I₁₈ is the intensity of light ray 18, is:

$${E}_{20} = \frac{{I}_{18} {cos}^{3} A}{{H}^{2}}$$

It is the goal of outdoor lighting systems to produce even illumination on the ground. If the illuminance at point 20 (FIG. 1) is equal to that at point 24 FIG. 1 then I₁₈ must exceed I₁₆. For this condition I₁₈ may be expressed in terms of I₁₆ as follows:

$${I}_{18} = \frac{{I}_{16}}{{cos}^{3} A}$$

For example if the value of H is 10 feet and S is fifty feet then

I₁₈=19.5 I₁₆

Thus it can be seen from this example that the light intensity in the main beam, of maximum intensity, must therefore be very substantially greater than that in a downward direction, in this case by a factor of 19.5, to produce optimum uniformity.

In FIG. 2, while additional illuminance will be produced at point 20 from adjacent luminaires, for simplicity of explanation only the light from luminaire 28, in FIG. 2, is taken into consideration in the following description.

FIG. 2 is a plan view of an outdoor lighting system where the goal is to light a straight section of roadway 26 with a series of luminaires, one of which is shown as 28. The width of the roadway is “T.” The luminaire at location 28 is required to light a length of roadway 26 indicated by the dimension S/2, where S is the spacing between two adjacent luminaires on two adjacent light poles. To produce optimum uniformity the maximum intensity must be directed to distant point 30 rather than point 20 of FIG. 1.

The intensity I₃₀ directed towards point 30 produces an illuminance E₃₀ at point 30 as given by

$${E}_{30} = \frac{{I}_{30} \cdot {H}^{3}}{{( {H}^{2} + {( S / 2 )}^{2} + {T}^{2} )}^{\frac{3}{2}}}$$

For equal illuminance at point 30 to that point 24, E30=E24, and:

$${I}_{30} = {I}_{16} \frac{{( {H}^{2} + {( S / 2 )}^{2} + {T}^{2} )}^{\frac{3}{2}}}{{H}^{3}}$$

For example where H=10 ft. and S=50 ft. and T=11.5 ft. (the common width of a highway lane), the value of I₃₀ is 25.1 I₁₆. Therefore the intensity directed at point 30 must be 25.1 times the intensity towards point 24 to produce equal illuminance. In a situation where two luminaires contribute equally to illuminating point 30, the maximum required intensity for substantially perfect uniformity is half of the value computed above.

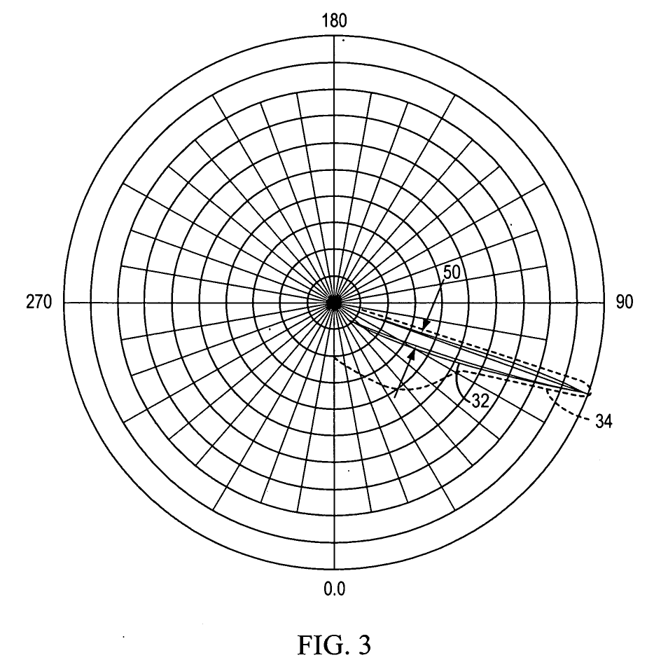

In practice the intensity towards the most distant point to be lighted is normally designed to be as large as possible and in such a case will be the maximum intensity from the luminaire. A vertical plane through the center of the luminaire and point 30 then is the “plane of maximum intensity.” The intensity distribution in this plane is frequently documented on a polar graph, the “maximum plane” graph. A theoretical intensity distribution may be developed using the mathematics and logic presented above for equal illuminance on all points on the ground intersected by the maximum plane. As an example, FIG. 3 shows the required intensity distribution, graph 32 solid line, to produce a uniform illuminance from the luminaire for the lighting system dimensions detailed above.

FIG. 3 also illustrates a maximum plane graph for a prior art luminaire showing a state of the art luminaire, and that there is considerable deviation in existing designs from the intensity distribution that is ideal, represented by solid line 32, for lighting the area.

It will be recognized that those skilled in the art will also take into account vertical planes other than the plane through the maximum intensity zone, when designing luminaire optical systems in order to achieve good uniformity of illuminance for the entire area being lighted, through the use of similar principles.

Similar principles apply, for example, to the lighting of outdoor areas such as parking lots. In such cases, it is common to use an array of poles in a square or rectangular based layout. Then point 30, FIG. 2, illustrates the ground level centerpoint of a group of four luminaires. Luminaires employed for such applications often are equipped with an optical system that produces an axially symmetric light pattern. That is, the light intensity distribution is similar in all vertical planes that intersect the luminaire center. The formulae developed above for producing uniformity of illuminance are applicable in these situations.

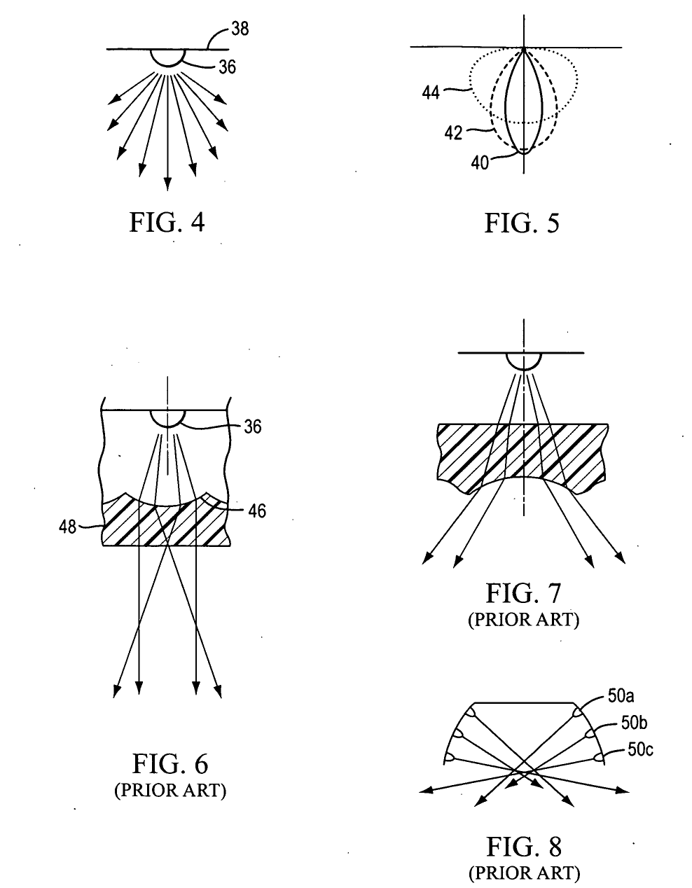

FIG. 4 illustrates a representative light-emitting diode, or LED, 36, of the variety that is commonly mounted directly to a backing plate 38. The backing plate frequently is a circuit board that supplies voltage to the LED. As is known in the art, LED's come in many shapes and configurations. Many of the alterative LED shapes will work well with this invention. Other embodiments of LED's can be cylindrically shaped with a rounded end, bullet shaped, or any other shape supplied by LED manufacturers. The ensuing description is applicable to LED's in general and is not limited to a particular variety of LED. The LED shown in the accompanying figures has a hemispherical shaped dome. This is one embodiment of LED dome shape contemplated for use by the inventors. Other LED dome shapes, such as less or more hemispherical shapes, or shapes having concave, convex or a complex curved light-emitting end or surface could be used in place of the hemispherical shaped dome shown in the figures. Furthermore, in the figures, the light being emitted from the LED is shown as being emitted from a single point. In most LED's the light is emitted from more than a single point. The inventors recognize this and have elected to show, for reasons of simplicity, a single point light source as representative of light being emitted from the LED even though the light of LED's used in a preferred embodiment will be emitted from more than a single point of the LED. The functionality and performance of the lenses disclosed herein is more easily conveyed by illustrating the light coming from a single point of the LED and, in the opinion of the inventors, a person of skill in the art would understand that a single point source is reasonable and adequate to illustrate the principles being disclosed in this disclosure.

As illustrated by FIG. 4, light rays are emitted primarily in a forward direction, usually with the maximum light intensity occurring in a direction coinciding with the axis of the LED. The light distribution pattern that is generated is dependent upon the LED shape and the extent to which the rays are refracted by the curved emitting surface of the LED.

FIG. 5 illustrates light intensity distribution curves 40, 42 and 44, showing respectively narrow, medium and wide light emission patterns, all of which are light distribution patterns of LED's that are commercially available.

It will be apparent from the foregoing descriptions of the physical nature and light distribution patterns of LED's, when compared to HID lamps, that optical systems developed for HID light sources are of little value for the control of light from LED's.

The light pattern generated by a solid-state light-emitting device, such as but not limited to an LED, may be modified by the use of a lens. An example of such an LED used with a supplemental lens can be found in LED-based traffic signals which may use a plurality of LED's aimed in a horizontal direction generally toward oncoming traffic. To meet lighting distribution requirements of the Institute of Transportation Engineers, a lenslet may be placed in front of each LED, such lenslets being formed in a sheet of injection molded plastic that covers the plurality of LED's. (This is not to say that the Institute of Transportation Engineers suggests that lenslets may be placed in front of each LED. The Institute only provides performance specifications for lighting systems.) Such a lenslet, 46, is shown in FIG. 6, molded into a plastic sheet 48 on the side nearest to the LED's (one LED shown in this figure.).

An alternative arrangement of lenslets is shown in FIG. 7 where the lenslets are molded into the opposite surface of the plastic sheet.

The prior art embodiments of the LED lens used for traffic signals shown in FIGS. 6 and 7 are unable to produce the light intensity distribution pattern shown by curve 32 of FIG. 3, which are generally desirable for outdoor lighting. The deviation of the light rays is achieved in these traffic signal embodiments by refraction, such refraction-only designs are unable to efficiently produce the deviation angles needed to form beams of light that are angled sixty degrees to seventy-five degrees from the LED axis, as is needed for uniform light distribution on the ground if the LED is directed to the nadir, that is, pointed essentially toward the ground.

A further example of a known LED luminaire configuration is illustrated in FIG. 8 where the individual LED's such as 50a, 50b and 50c, are aimed in different directions to form the overall desired light distribution pattern. These LED's may be attached to a single flat surface but set at different angles, or may be attached to a curved surface that forms the desired aiming directions.

The type of luminaire illustrated by FIG. 8 is expensive to produce as the angle of each LED must be proper for the intended purpose. This is particularly so because for economy in manufacturing it is desirable to use a flat circuit board for mounting the plurality of LED's, and thus individual aiming of each LED becomes problematic.

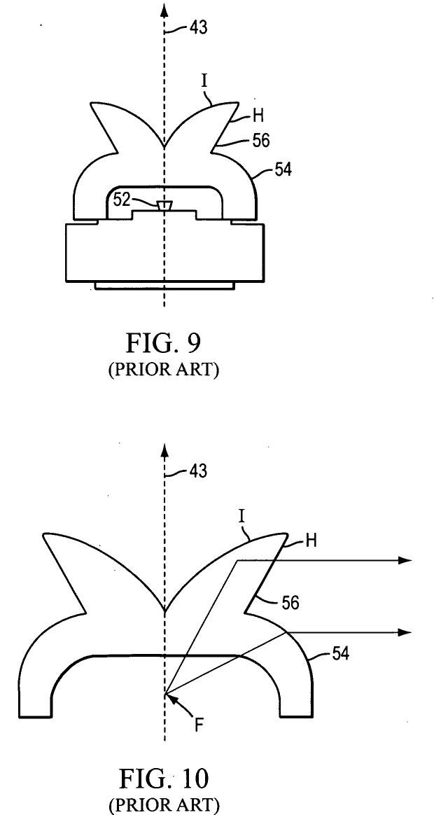

A variation of the embodiment shown in FIG. 8 uses a flat circuit board on each side of the luminaire, with all LED's on one side of the luminaire aimed in the same direction. This known embodiment, as well as that shown in FIG. 8, suffers from a further significant limitation: the minimum angular width of the beam that is created cannot be smaller than the inherent width of the light distribution of the individual LED's. As can be seen from curve 32 of FIG. 3, the angular beam width 50 that is desired is small in comparison to the angular width of the light intensity patterns generated by typical LED's, as shown by the three light patterns in FIG. 5. Therefore the light produced in the current offering of LED luminaires is insufficiently concentrated in its angle. Moreover, there is considerable light produced at angles above the maximum intensity with such an arrangement. This results in a high level of glare. Thus in current embodiments of LED luminaires even if all the LED's on one side of the luminaire are aimed at a common angle, thereby reducing manufacturing difficulties, beam spread remains a significant problem. FIGS. 9 and 10 are cross section views of LED and LED lenses, where a prism structure, the lens 54, is positioned in proximity to, or cemented to, the surface of an LED. The figures are taken from U.S. Pat. No. 6,679,621 B2, herein incorporated by reference in its entirety. LED 52 of FIG. 9 is positioned at “F” of FIG. 10. As shown in FIG. 9 light rays emitted from “F” may strike surface “I” and be totally internally reflected, and then be refracted by surface “H” to be emitted in a direction that is substantially perpendicular to the central axis of the LED and lens. Light rays also may be intercepted by surface 54, where they will be refracted to lie also in a direction substantially perpendicular to the axis of the LED or lens. As will be recognized from the foregoing, the light distribution pattern so produced will not be usefully applicable to the lighting of outdoor areas. The lens 54 of FIGS. 9 and 10 is also difficult to mold because of the side recess in the lens surface where 56 meets 54.

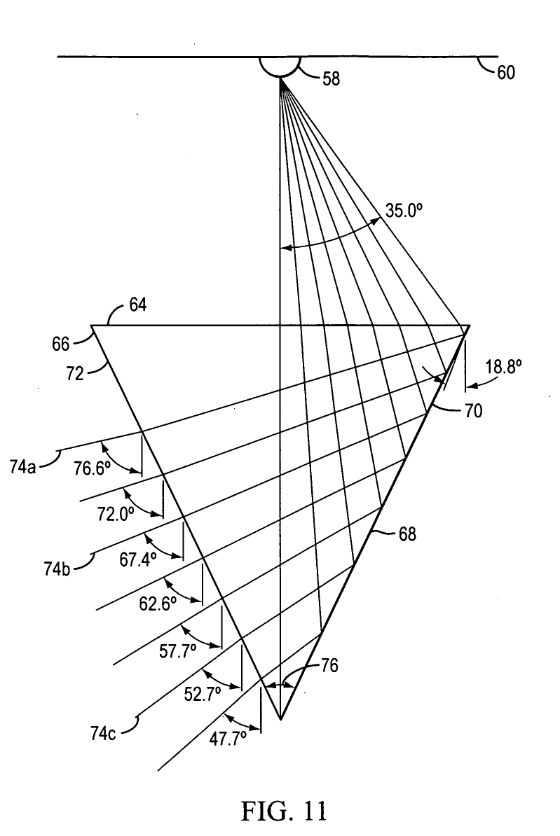

FIG. 11 pictorially illustrates one embodiment of the present invention. LED 58 is mounted on a surface 60 that may be horizontal and the LED 58 is aimed in a generally downward direction, the nadir direction. Situated beneath the LED 58 is a conical prism with its axis corresponding to the LED axis. The prism has a flat top surface 64 and a generally Vee-shaped surface 66, as seen in the FIG. 11 vertical cross sectional, presentation of the prism. The cone 68 is shown diagrammatically as surfaces 70 and 72, although in fact 70 and 72 are a single conical surface of cone 68.

Light rays such as, 74a, b and c, but not limited to these only, are emitted from the LED and refract as they are transmitted by surface 64. Each of these rays strikes the right illustrated surface 70 at angles greater than the critical angle and therefore the light rays undergo total internal reflection.

Light ray 74b is illustrated as traveling at an angle parallel to the normal of surface 72, and therefore it is transmitted through surface 72 without deviation. Light ray 74a forms an angle to surface 72 such that it is refracted in an upward direction; i.e. it is elevated to a greater angle as measured from nadir or the zero degrees direction. Light ray 74c is angled to the normal to surface 72 such that it is refracted to a lower angle, that is, the direction of this light ray is depressed.

Prisms, conical prisms, or in some of the embodiments set forth herein sometimes referred to as “conically shaped light-transmitting elements,” of the form illustrated by FIGS. 11, 12 and 13, among others, which employ both the use of total internal reflection and refraction respectively on opposite facing surfaces, are termed “splitting prisms.” Lewin for example, U.S. Pat. No. 4,262,326, herein incorporated by reference in its entirety, recites the use of a series of splitting prisms having flat sides and running horizontally. These are employed on the sidewall of a drop-lens in conjunction with a HID lamp, used in a ceiling mounted luminaire. Light is split into an upward direction to light a ceiling, while other light rays are directed downward to assist in the lighting of surfaces below the luminaire.

It will be recognized by those skilled in the art that the apex angle, apex angle 76 in FIG. 11 for instance, of the conical prism will affect the angles of the internally reflected rays. An increased apex angle will cause elevation of such reflected rays. The apex angle also will determine the extent of the refracted rays that are elevated versus those that are depressed on exiting. Thus the resultant light distribution can be altered by variation of the cone apex angle.

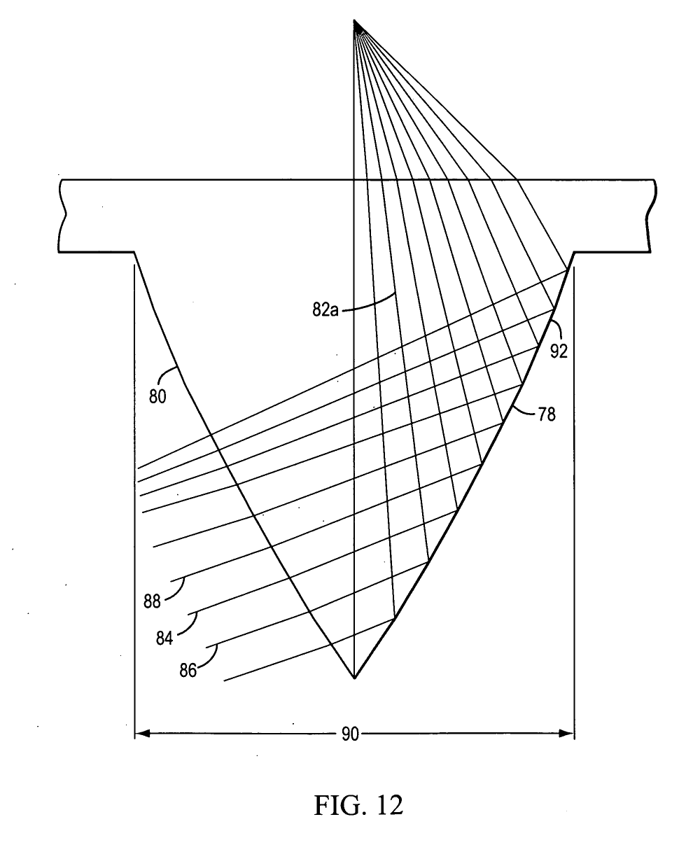

Because rays 74a, 74b and 74c, as illustrated in FIG. 11, leave the splitting prism at different vertical angles, the angular spread of the beam so produced will be widened versus that which would be produced if all rays were parallel. As a result the intensity of the beam will be comparatively reduced. FIG. 12 illustrates a further embodiment that allows the production of light rays that more closely approach parallel than those of FIG. 11, having increased beam intensity in a predetermined direction. Elements 78 and 80 illustrate the single surface of an inverted cone-like structure having a convex curved profile. By this means, ray 82a is reflected from element 78 to a higher vertical angle than ray 74c of FIG. 11. Ray 82a then is refracted to a still higher vertical angle to be emitted in a preferred direction versus ray 74c. Similar action is provided to ray 84a as compared to ray 74b, such that ray 84a is near-parallel to ray 86. Ray 88a undergoes total internal reflection and refraction in a manner similar to ray 74a, and also is emitted near-parallel to ray 86. Thus there is a major concentration of rays in a generally similar preferred direction, resulting in high light intensity in that direction.

By increasing the diameter 90 (FIG. 12) of the splitting prism, the angular range of rays emitted by the LED that is captured is also increased. More light thus is directed in preferred directions. If the prism diameter 90 is made too large however, a ray striking the upper end of the splitting prism, for example at location 92, may have an angle of incidence that is less than the critical angle, and such a ray will be refracted to an angle near to nadir rather than being totally internally reflected, although it is not shown as such in FIG. 12. To prevent this, the face of the prism at locations near to 92 must be nearer to vertical that at other parts of the surface closer to the prism apex than point 92. This can satisfactorily achieve total internal reflection, refraction from surface 80 and subsequent emission, but the angle of emission for such a rays will be lower than that of the main beam created by rays 88, 84 and 86. Never-the-less, this light is highly useful as it will illuminate the ground at a distant location that is closer to the luminaire than those points illuminated by rays 88, 84 and 86. In fact, by proper choice of curved profile 78 and 80, an intensity distribution curve closely resembling the example ideal curve 32 illustrated in FIG. 3 can be produced that satisfactorily illuminates a wide range of distant points with desirable uniformity.

As will be recognized by a person of skill in the art, the LED is not a point source of light. Because of the physical size of the LED, rays will be generated by the LED at all points on its light producing element. This will result in an angular spread of the light rays emitted by each point on the curved splitting prism surface 78/80. In one embodiment this is a continuously curved surface. However, by developing the profile 78 and 80 based on rays emitted from the center point of the LED a favorable distribution of light for the lens system will be produced.

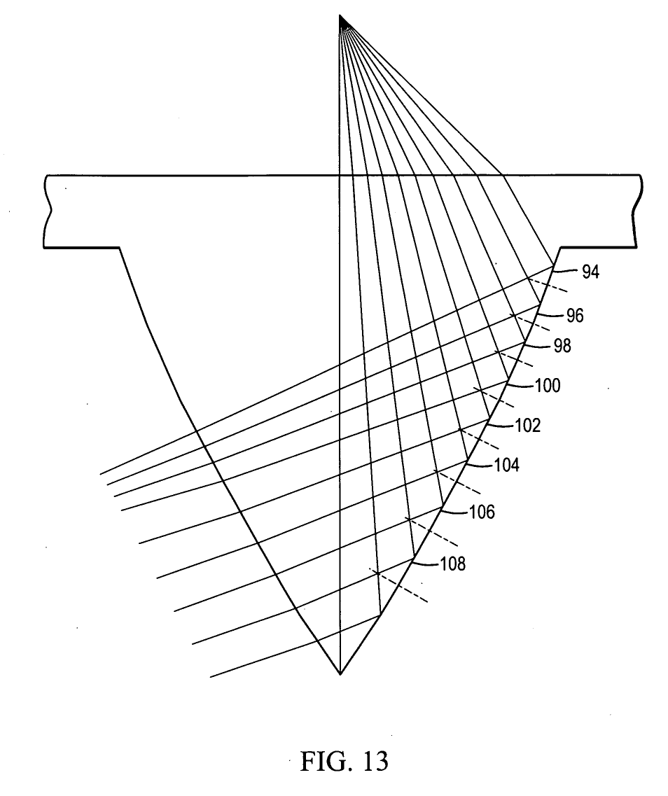

FIG. 13 illustrates a similar embodiment to FIG. 12. Here curved element 78 of FIG. 12 has been replaced by a series of flat elements, namely faceted bands 94, 96, 98, 100, 102, 104, 106 and 108 which form a generally similar profile to element 78 of FIG. 12. The resultant distribution of light from the series of flat facets therefore will be close to that produced by the curved surface illustrated in FIG. 12.

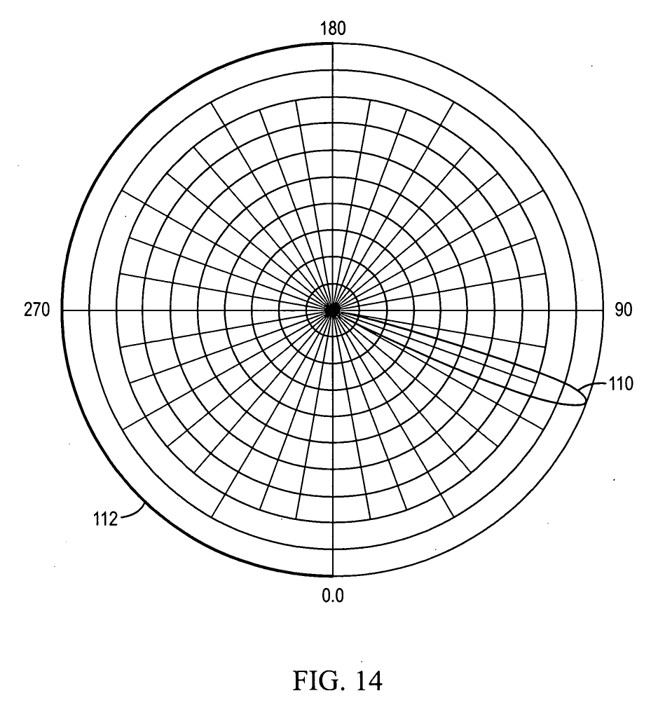

The distribution of light produced by the LED and splitting prism of FIG. 11 or FIG. 12 is illustrated in FIG. 14. The right side curve 110 illustrates the maximum plane intensity. The left side curve 112 shows the graph of intensity through the vertical angle of the maximum intensity for a range of horizontal angles of zero degrees to one hundred eighty degrees, per the coordinate system illustrated in FIG. 3. This left side curve is referred to as the “maximum cone” intensity graph, and it is circular because of the circular form, in plan view, of the LED and the generally cone shaped prism.

It will be recognized that the actual size and shape of the conically shaped light-transmitting element, and its spacing from the LED, can be varied to create different patterns of light. For example, increasing the apex angle of the conically shaped light-transmitting element will cause the internally reflected rays to be elevated further and emitted at a higher vertical angle.

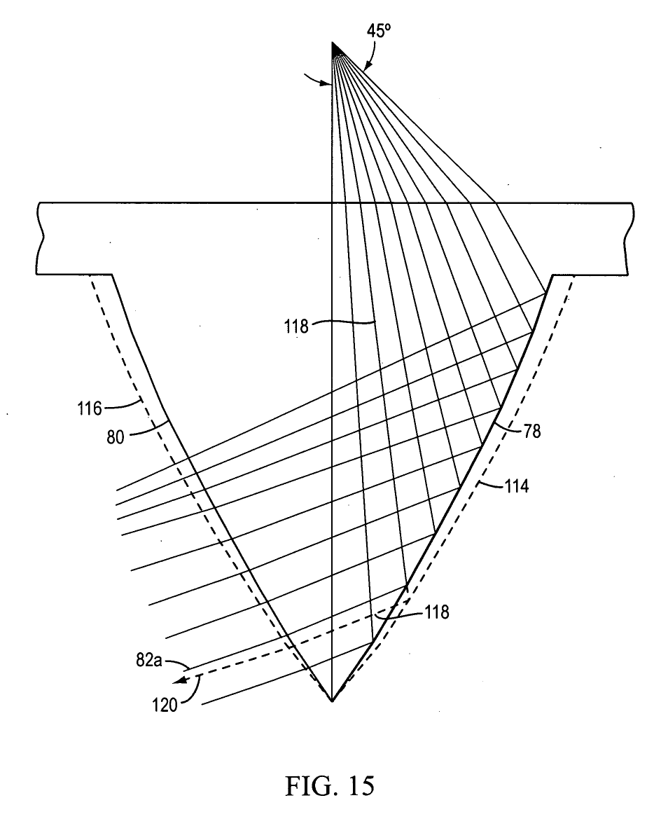

FIG. 15 shows a prism having a wider prism angle, represented by a broken line curve, 114/116, than that shown in FIG. 13. Elements 78 and 80 of FIG. 12 are shown in a FIG. 15 solid line representation of the curve, as is ray 82a, for comparison. For the wider cone, represented by the broken line representation, ray 118, which in FIG. 12 is denoted as ray 82a, is reflected by surface 114 to a comparatively higher angle and is refracted to be emitted as ray 120 at a higher vertical angle than ray 82a of FIG. 12. Thus, as will be understood by a person of skill in the art, a range of beam elevations can be achieved by varying the prism apex angle.

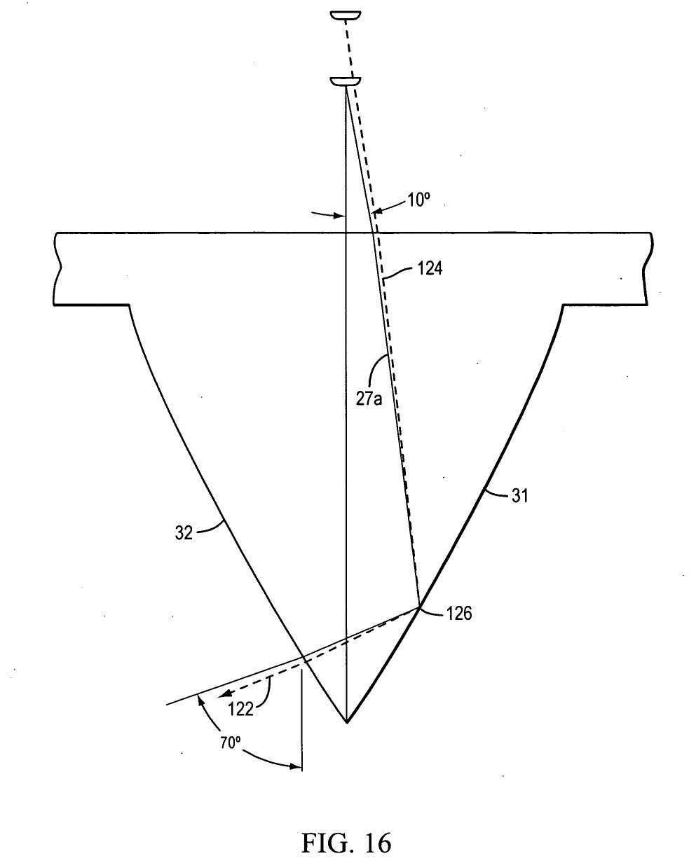

It will also be understood that a change in the distance of separation between the LED and the conically shaped light-transmitting element will alter the angle of maximum light intensity. FIG. 16 shows an increased separation of the emitted beam of light by elevation of the LED, shown as a broken line 122. Ray 124 is incident at an identical point on surface 78 to ray 86, of FIG. 12. The angle of incidence of ray 124 is greater than that of 86, and it is thus reflected at point 126, and subsequently emitted to a lower angle, as shown by ray 122.

The foregoing discussion has described the optical control of that portion of the light output from an LED that is emitted by the LED and is captured by the conically shaped light-transmitting element. The proportion of the LED's light output so captured will vary depending on the width of the LED's light output distribution, FIG. 5.

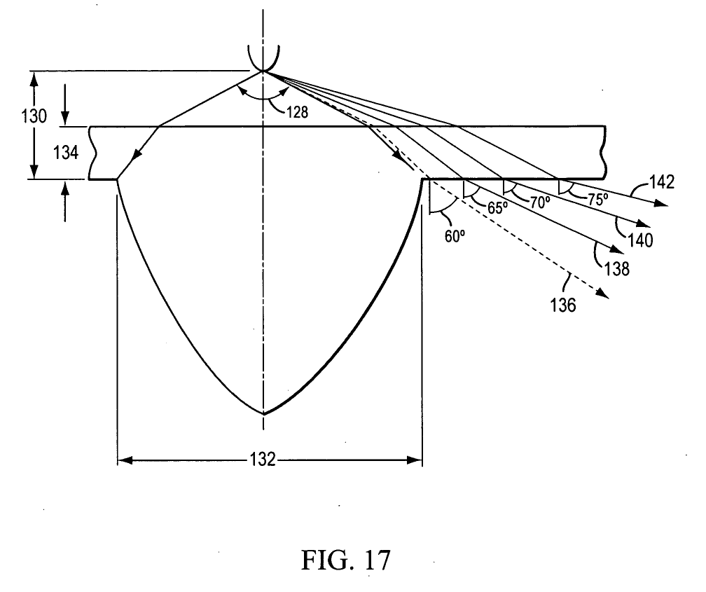

FIG. 17 illustrates the splitting prism formed on the bottom surface of a sheet of light-transmitting plastic or other material, 134, although it will be recognized that other methods of positioning the prism beneath the LED may be employed, as later described.

Light rays emitted by the LED outside of the angular range at apex 128 will pass through the plastic sheet and will be subsequently emitted, for example, as ray 136. Such rays will add to the total light output of the system. For the forms of light distribution generally desired for outdoor lighting, ray 136 contributes usefully to the overall emitted pattern of light. Ray 136 is illustrated as the lowest angle ray that is emitted without being captured by the splitting prism. Geometry of the LED and splitting prism, and in particular diameter 132, may be chosen such that this limiting ray 136 is emitted at a chosen vertical angle that is useful for typical outdoor lighting distributions, for example, at sixty degrees. Further rays 138 and 140 are illustrated as being emitted at vertical angles of sixty-five and seventy degrees respectively, and they also contribute to the useful light pattern.

It will be recognized, that if the desired light distribution is to be concentrated approximately in the vertical angular zone of sixty to seventy degrees from nadir with the highest intensity of light at the upper end of this range, the principles illustrated by FIGS. 12 through 17 form a combination of methods of light control that will yield such a light distribution when the angles and dimensions are appropriately selected. The angle of the lowest light ray, 136, that is emitted without striking the splitting prism, or conically shaped light-transmitting element, can be selected by appropriate choice of dimensions 130 and 132 to be emitted at the low end of the desired angular output range. Rays 138 and 140 add to the output in the sixty to seventy degree range. The highest desired intensity of light, which may be at or just below seventy degrees, is created through the previously described process of total internal reflection and subsequent refraction by the splitting prism. At angles greater than seventy degrees, the emission of light intensity reduces; for example, ray 142 is emitted by the LED at an angle where the light intensity from an LED is comparatively small.

For variations in the desired lighting pattern, for example for when luminaires are spaced more closely together than as described above, the preferred angular zone of emission may be, for example, fifty to sixty degrees, or fifty-five to sixty-five degrees. It will be understood that alteration of angles and geometry of the optical system will allow lighting system designers alternatives for these other example requirements.

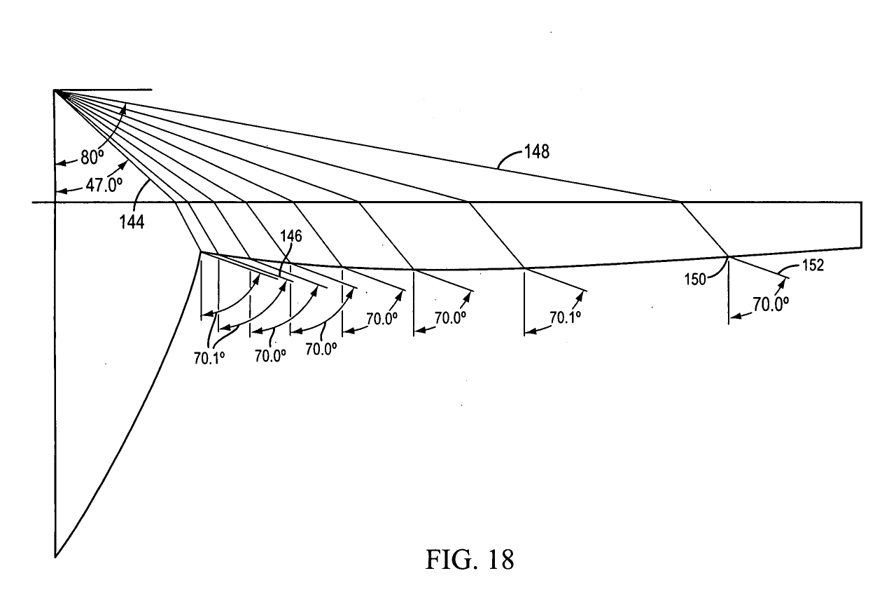

As has been previously described in relation to FIG. 12, the angle of the prism surface at point 78a must be such that a ray incident at that point undergoes total internal reflection. This limits the maximum diameter of the base of the splitting prism 90, for if the maximum diameter of the base of the splitting prism is increased too greatly, rays striking the upper portion of the splitting prism may be refracted to undesirable directions. As a result of this consideration, ray 136 of FIG. 17, which is the lowest angle ray not intercepted by the splitting prism, may be emitted at an undesirably low angle. For example, FIG. 18 illustrates a splitting prism of otherwise desirable dimensions, but ray 144 incident on the top surface at an angle of forty-seven degrees to the vertical would not be intercepted by the splitting prism. If the sheet of light-transmitting plastic 64 has parallel planar top and bottom surfaces as illustrated in FIG. 17, ray 144 will be emitted by the bottom surface at an angle of forty-seven degrees. If, however, the bottom surface surrounding the splitting prism is not planar but has a downward slope at points in proximity to the splitting prism, ray 144 is elevated to a chosen angle by refraction to be emitted as ray 146 at a higher angle.

As previously stated, light rays may be emitted at angles higher than the desirable range. Light ray 148, FIG. 18, is emitted by the LED at an angle of eighty degrees from nadir. Thus it will be emitted from a transparent sheet that has planar parallel surfaces at eighty degrees. However, for a sheet, such as is shown in FIG. 18 where the top and bottom surfaces of the sheet are not parallel, this ray will intercept the bottom surface, at point 150. The bottom surface profile may slope upwards from the base of the splitting prism and this ray thereby can be refracted to a lower angle versus its angle of emission from the LED. In FIG. 18, ray 152 is emitted at approximately seventy degrees from nadir.

From the illustration of FIG. 18 it can be seen that a ring-shaped structure surrounding the splitting prism can be constructed to concentrate the intercepted rays into a preferred angular output range. The distribution of useful light is increased as a result and by lowering of the angle of rays that otherwise would be emitted at angles approaching the horizontal glare emission is reduced or eliminated.

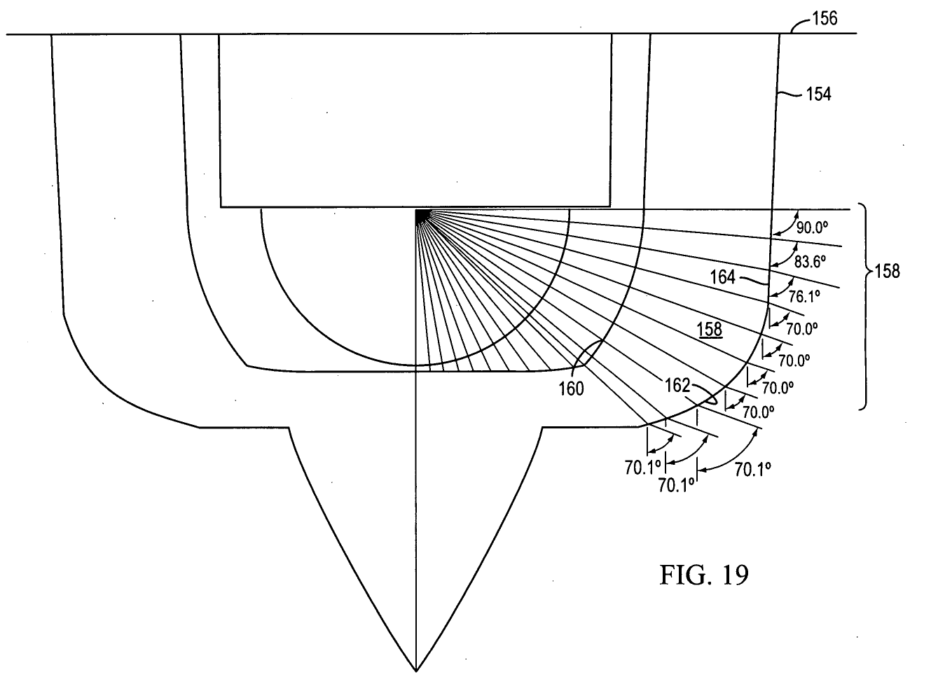

An alternative embodiment of the invention is shown in FIG. 19. The splitting prism is positioned beneath the LED similar to the embodiment shown in FIG. 17. However, rather than having the splitting prism formed on or adjacent to the generally horizontal sheet of light-transmitting material an extension to the splitting prism is provided. This extension is a perimeter wall portion 154, in one embodiment extending to the upper surface 156, the same surface on which the LED is mounted. Joining the splitting prism to the perimeter wall portion 154 is a standoff section transition zone or volume 158. Perimeter wall portion 154 can have a diameter that becomes smaller toward the bottom of the wall, i.e. away from the upper surface 156 area. This provides a desirable mold release angle and an advantage in manufacturing over lenses that have undercuts and complex shapes such as is shown in FIGS. 9 and 10. It should be pointed out that the inventors contemplate embodiments where the extension between the surface 156 and the bridge or bridging surface on which the conically shaped light-transmitting element is carried can be a circumferential perimeter wall or a perimeter wall portion having other shapes, such as rectangles, squares, oblong shapes, and the like, as circumscribed by a peripheral wall.

The inner wall or first surface 160 of the standoff section transition zone 158 of the lens can be shaped so that the normal to the surface at any point is parallel to the incident ray from the LED center, in which case no refraction will occur at first surface 160. By applying curvature 162 to the lower portion of the outer surface of standoff section transition zone 158, light rays incident thereon can be elevated by refraction to be emitted at preferred angles. By maintaining a near-vertical profile 164 on the upper portion of the outer surface of standoff section transition zone 158, light rays incident thereon are depressed in their vertical angle.

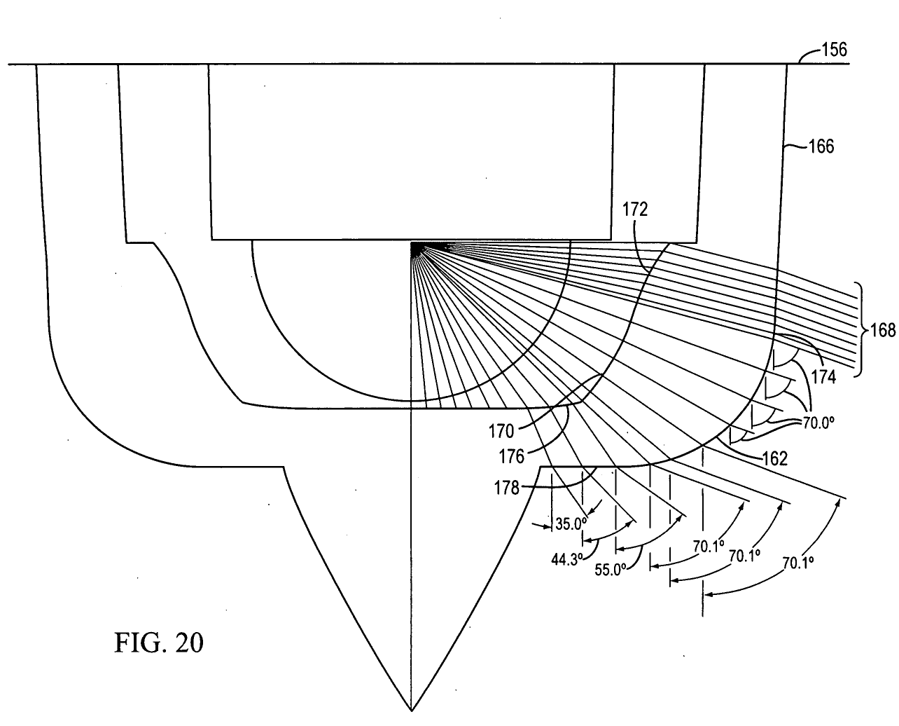

A modified embodiment of the embodiment shown in FIG. 19 is shown in FIG. 20 where the peripheral wall and curved sections between the wall portion of the perimeter wall and the bridge surface of FIG. 19 have been modified, providing a peripheral wall portion of reduced wall thickness, 166, and a light ray directing section 168. A portion 170 of curved inner surface of the sidewall of the lens is shaped as in the embodiment illustrated by FIG. 20. It is shaped to have a curved surface matching the radius of the center of the LED lens so that light rays incident on the curved surface of the splitter prism pass without refraction at this first surface to be emitted by refraction at the second surface 162. The upper part 172 of the inside surface is of a generally convex shape, and is formed such that rays received from the LED center in this convex shaped zone are all refracted to be parallel to each other. Upon being incident upon the outer surface 174, such rays are refracted into a preferred direction, for some applications, such as but not limited to seventy degrees from nadir. A direction less than or greater than seventy degrees from nadir is contemplated by the inventors depending on lighting requirements, seventy degrees being mentioned as it is a specification for some lighting situations in place today.

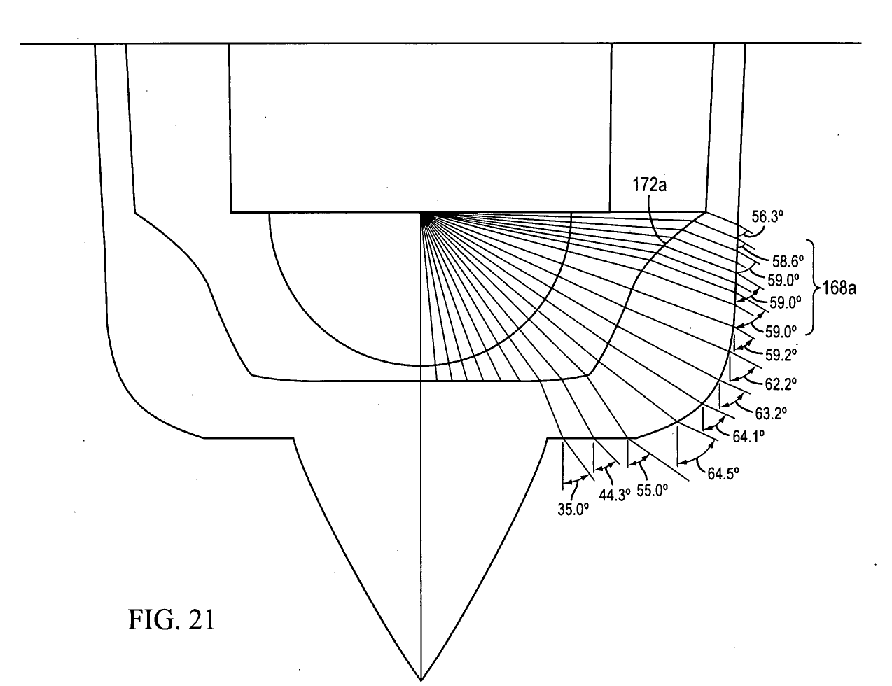

A yet further embodiment is a modification of that shown in FIG. 21, which provides certain benefits when multiple prisms are used in combination with a plurality of LEDs mounted on a planar surface. If the LED's are spaced closely together, some light rays emitted by sections 162, 174, and 168, FIG. 20, may be intercepted by a prism being used in combination with an adjacent LED. Such rays will be refracted by the adjacent lens and will be elevated to undesirable angles, where a viewer may perceive them as glare. For closely spaced LED's modified profiles as shown in FIG. 21 can be used. Here section 172a is inclined more steeply away from the vertical than section 172 of FIG. 20. This results in a lowering of the angle of rays emitted, for example by section 168a, such that the rays pass beneath the adjacent lens rather than striking it and undergoing refraction.

As will be understood by a person of skill in the art, the prism or conically shaped light-transmitting element arrangement illustrated in FIG. 20 has high optical efficiency, as angles of incidence at refracting surfaces are all relatively small and thus surface reflections, also known as Fresnell losses, are slight.

The embodiments described above provide a concentrated beam of light in directions where maximum intensity is usually desired for outdoor lighting applications. They do so with very high efficiency and virtually eliminate light rays traveling at lower angles. However, there is still a need for light at angles below that of the maximum intensity to avoid dark areas that would otherwise result. Emission at such angles is achieved by section 176 of the inner surface in combination with section 178 of the outer surface, FIG. 20, whereby light rays are refracted by both surfaces to be emitted in the general range of approximately thirty degrees up to the angle of the maximum intensity. Section 176 may have slight upward inclination, either planar or non-planar, to provide slight elevation of the refracted rays versus the ray angles that would be provided by a horizontal surface. Likewise, section 178 may be inclined to the horizontal to modify the emitted angle of the refracted rays.

It will be understood that reduced intensities are required of rays emitted at angles lower than that of the maximum intensity. This is achieved by the embodiment shown by FIG. 20, as the length of section 178 is substantially smaller than the total length of sections 166 through 168, and thus the light intensities over the angular range of emissions created by section 178 are relatively low.

With the prismatic structure described in relation to FIGS. 20 and 21, no light is emitted at or close to nadir. This can result in areas on the ground close to the luminaire having an unsatisfactorily low illuminance. In a further embodiment, which may be derived from any of the previously described embodiments, the shape of the splitting prism can be modified to allow controlled emission of light rays at low vertical angles. By limiting the intensity of such rays, the ground areas close to directly beneath the luminaire can be lighted to an illuminance level fairly similar to areas lighted by the main beam, thus achieving a desired uniformity.

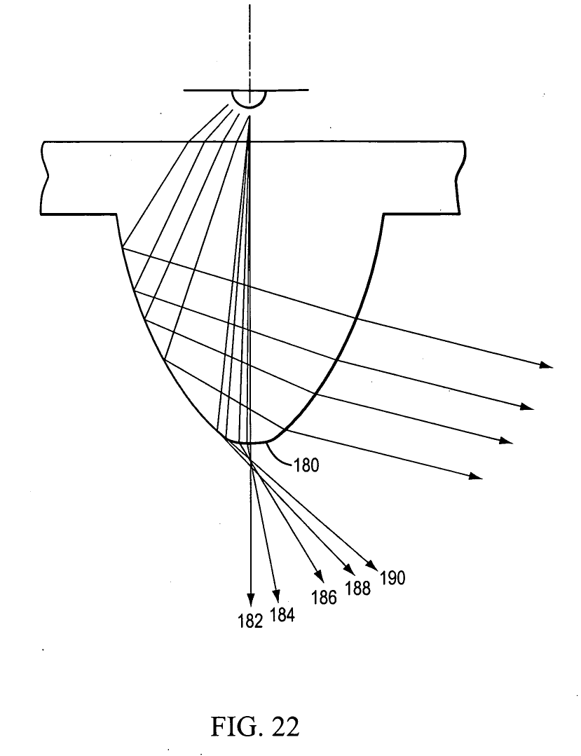

FIG. 22 illustrates such a modification where the apex 180 of the prism is rounded and convex. Because of this rounding, rays incident thereon fall at less than the critical angle and thus are refracted. The general form of light emission, as illustrated by rays 182, 184, 186, 188 and 190, is as desired to produce low intensity at those angles that are lower in vertical angle than the primary beam.

It will be understood that, if a conically shaped light-transmitting element or prism of any of the various embodiments is injection molded, the molding process itself will produce some rounding at the prism apex. However, the extent of rounding illustrated in FIG. 22 exceeds that that is normally unintentionally created in the injection molding process.

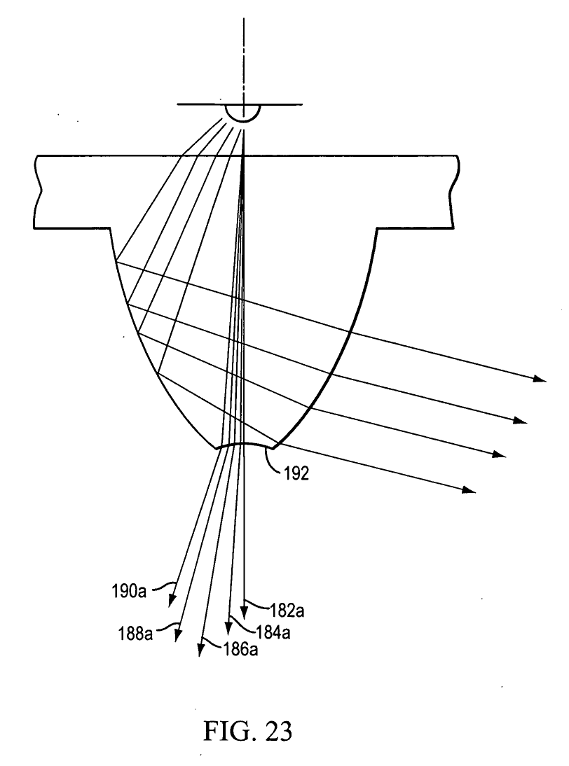

A further embodiment is show in FIG. 23, where the apex 192 of the splitting prism has been supplanted by a concave area, 192, that similarly provides a spread of low intensity light rays at low vertical angles 182a, 184a, 186a, 188a and 190a.

As has been described, when a plurality of LED's is to be formed in an array where the aiming direction of all the LEDs is identical, it is normal practice to mount each LED on a single planar support surface, 156, FIG. 19. Such a surface can be a circuit board or a metal sheet. Preferably the mounting surface will be reflective such that any rays emitted by the LED and lens combination will be reflected and will add to the useful downward light. Even if an LED emits no upward light when it is aimed in a downward direction as shown for example in FIG. 19, reflections will occur at the surfaces of the prismatic structure resulting in some upward directed rays.

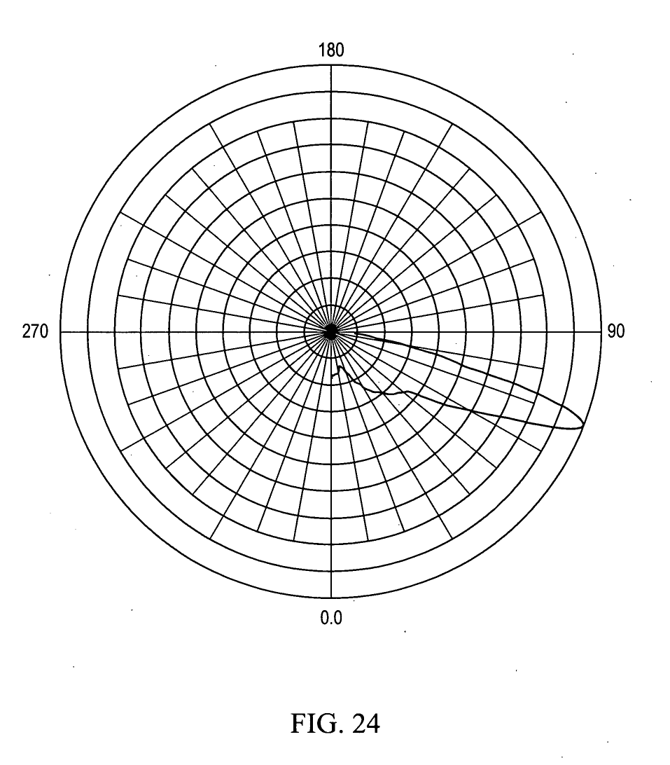

The overall performance achieved by an array of LED's and lenses of the general form as illustrated by FIG. 19, when mounted on a semi-specular planar reflective surface, may be very close to the ideal intensity distribution shown by curve 32 of FIG. 3. The exact form of light distribution will be dependent partially on the native light distribution pattern of the LED itself. By way of illustration, FIG. 24 shows the intensity distribution achieved using an LED, such as a “Z-Power” LED, believed to be model W11190 (a white LED) manufactured by Seoul Semiconductor, in combination with the optical system of the form illustrated by FIG. 19. Many LED's are available and many of the available LED's will work well with the lenses presented herein. As mentioned above, no particular LED, or LED shape is a limitation to the applicability of the lens configurations presented herein.

Attachment of the LED's to their mounting plate may be achieved by well known means, this most commonly being the soldering of the LED leads to the appropriately positioned terminals on a printed circuit board. Attachment of the individual lenses over the LED's can be achieved by several simple means. For example, a small flange can be added to the upper perimeter of the lens, and this flange can be fastened to the mounting plate by means of screws or rivets. The lens also may be attached to the mounting plate by the suitable adhesive. By forming the interior diameter of the cylindrical upper portion of the lens to be just slightly greater than the equivalent dimension of the LED, a small amount of adhesive can be applied between the two. The mating of the two surfaces can then provide accurate registration of the lens with its LED.

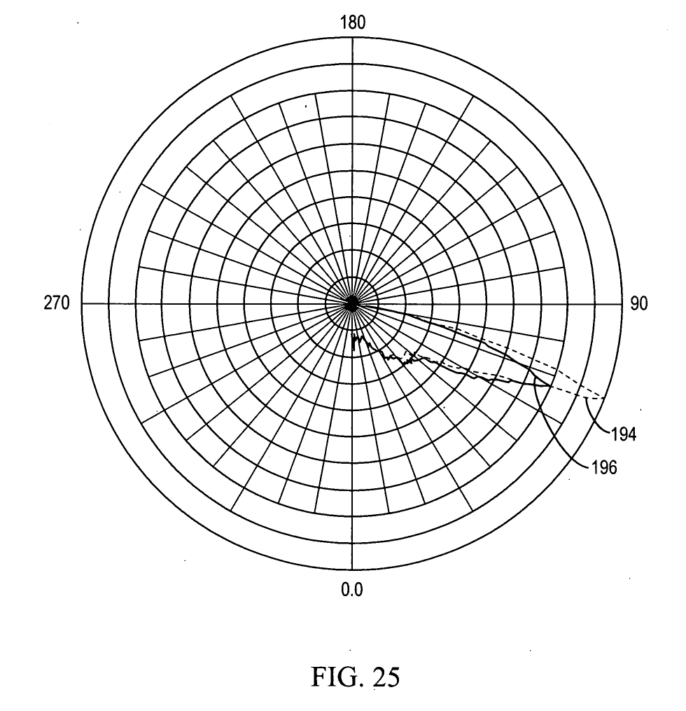

The light-generating element of an LED is commonly rectangular or square rather than round. Because of this, the light distribution produced by an LED/lens combination of the invention will not be precisely axially symmetric. A difference will exist in the light pattern in a vertical plane through the axis of the LED and lens that is parallel to one edge of the light generating chip versus an otherwise identical plane that intersects a diagonal through the rectangular or square light generating chip. It has been discovered that the light intensity pattern in a diagonal plane contains a higher maximum intensity, and occurs at a higher vertical angle, that the light intensity pattern generated in a plane parallel to the edge of the light-producing element within the LED, for LED/lens embodiments of the present invention. This is illustrated by FIG. 25 where curve 194 shows the light pattern generated by an LED/lens combination of the form shown by FIG. 19, for a vertical plane through the diagonal of a square light producing element. Curve 196 shows the equivalent distribution for a plane that is parallel to one edge of the square light-producing element. When lighting square or rectangular areas, as has been described in relation to FIG. 2, light to the most distant point to be lighted by a luminaire, point 30 of FIG. 2, should preferably be of higher intensity than light in other directions, and this highest intensity should be at a higher vertical angle than, for example, the maximum intensity of light in the ninety/two seventy degree plane as illustrated in FIG. 2.

It follows therefore that it is advantageous for the production of uniform lighting to have the light producing element within the LED oriented such that a line between two opposite corners of the element lie in a horizontal direction that is parallel to a line on the ground running from a point directly beneath the luminaire to the point midway between luminaires at the distant side of the area being lighted. For example, if a square light-producing element within an LED is to be used to light an area as shown by FIG. 2, the diagonal of the element should be oriented to lie in the direction formed by point 28 and 30.

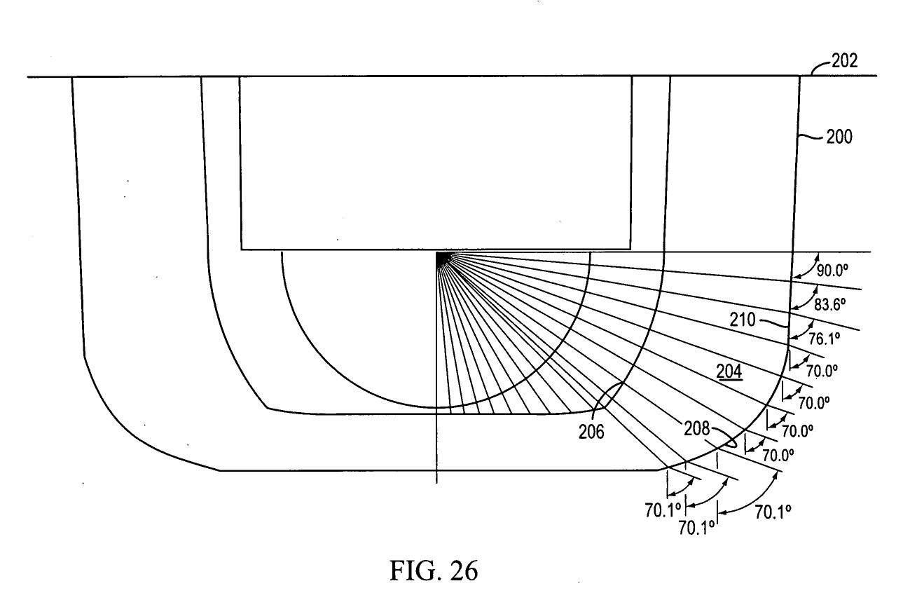

In yet another embodiment of the invention a lens device similar to the device show in FIGS. 19-21, however not including a conically shaped light-transmitting element or splitting prism, is contemplated. In the embodiments shown in FIGS. 26-28 there is no conically shaped light-transmitting element or splitting prism included in the lens. The surface under the LED may be coplanar or have shapes that cause refraction. Such an embodiment or embodiments may produce good illumination uniformity since the cylindrical portion of the lenses is very effective. This is particularly true with judicious lamp pole spacing compatible with the lens and LED system.

A first of these alternative embodiments is shown in FIG. 26. The lens includes peripheral wall portion 200 extending to the upper surface 202, the same surface on which the LED is mounted. The peripheral wall element 200 includes a standoff section transition zone or volume 204. Peripheral wall portion 200 can have a dimension that becomes smaller toward the bottom of the cylinder, i.e. away from the upper surface 202 area.

The inner wall of the standoff section transition zone 204 of the lens can be shaped so that the normal to the surface at any point is parallel to the incident ray from the LED center, in which case no refraction will occur at first surface 206. By applying curvature 208 to the lower portion of the outer surface of standoff section transition zone 204, light rays incident thereon can be elevated by refraction to be emitted at preferred angles. By maintaining a near-vertical profile 210 on the upper portion of the outer surface of standoff section transition zone 204, light rays incident thereon are depressed in their vertical angle.

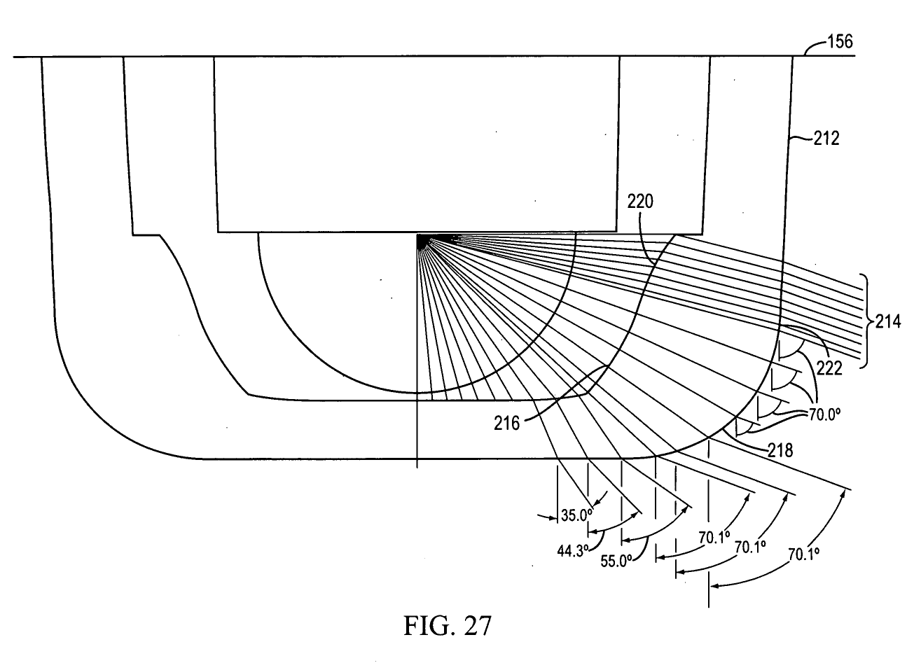

A modified embodiment of the embodiment shown in FIG. 26 is shown in FIG. 27 where the peripheral portion and flared volume portion at the curve of FIG. 26 have been modified, providing a peripheral portion of reduced width, 212, and a light ray directing section 214. A portion 216 of curved inner surface of the sidewalls of the lens is shaped as in the embodiment illustrated by FIG. 27. The curved inner surface sidewall is shaped to have a radius centered on the light-emitting element of the LED so that light rays incident on the curved surface of the hosting lens pass without refraction at this first surface and are subsequently emitted by refraction at the second surface 218. The upper part 220 of the inside surface of element 212 is of a generally convex shape, and is formed such that rays received from the LED center in this convex shaped zone are all refracted to be substantially parallel to each other. Upon being incident upon the outer surface 222, such rays are refracted into a preferred direction such as, in one embodiment, but not limited to, seventy degrees from nadir.

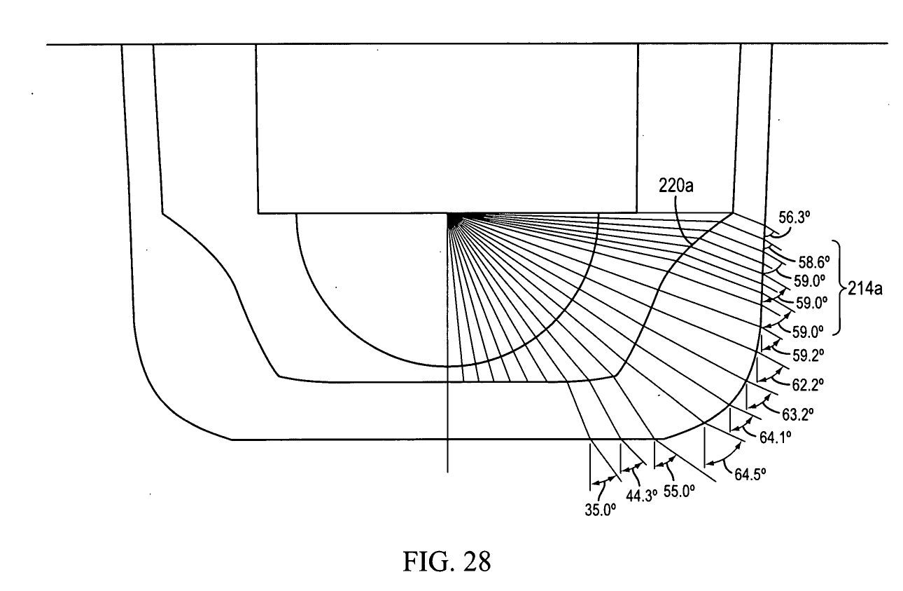

A yet further embodiment is a modification shown in FIG. 28, which like the design illustrated in FIG. 21, provides certain benefits when the multiple lenses are used in combination with a plurality of LEDs mounted on a planar surface. If the LED's are spaced closely together, some light rays emitted by sections 218, 222, and 214, FIG. 27, may be intercepted by an adjacent LED lens. Such rays may be refracted by the adjacent lens. For closely spaced LED's modified profiles as shown in FIG. 28 can be used. Here section 220a is inclined more steeply away from the vertical than section 220 of FIG. 27. This results in a lowering of the angle of rays emitted, for example, by section 214a such that the rays pass beneath the adjacent lens rather than striking it and undergoing refraction.

In summary of the inventions disclosed herein, one embodiment of the invention is a lens for use with a solid-state light-emitting device. The device has an axis, with the lens comprising a substantially conically shaped light-transmitting element positioned proximate the solid-state light-emitting device. The light-transmitting element has a major axis substantially aligned with the axis of the solid-state light-emitting device. There is a profile formed on the light transmitting element culminating in an apex pointing away from the solid-state light-emitting device when the light-transmitting element is positioned proximate the solid-state light-emitting device. This apex is substantially coaxial with the axis of the solid-state light-emitting device. The conically shaped light-transmitting element comprises a base, an apex and a curved surface body extending from the base to the apex and a major axis passing from the base through the apex of the curved surface body. In one embodiment of the invention light entering the conically shaped light-transmitting element exits the conically shaped light-transmitting element after the light is refracted at the curved surface body of the conically shaped light-transmitting element. In this embodiment light exiting the conically shaped light transmitting element exits from the refracting surface of the curved surface body at angles of between fifty degrees and eighty degrees from the major axis of the conically shaped light transmitting element.

In one embodiment, the conically shaped light-transmitting element may comprise a surface for redirecting a maximum intensity of light emitted from the solid-state light-emitting device in a pattern of fifty to eighty degrees from the major axis of the curved surface body.

In some embodiments disclosed above the conically shaped light-transmitting element is a splitting prism while the solid-state light-emitting device may be a light emitting diode.

One embodiment of the invention set forth above can be summarized as being a luminaire comprising a planar surface that has an array of solid-state light emitting devices carried thereon. Each device has an axis and an array of lens elements. These lens elements may have a substantially conical element defining an axis from a base to an apex. Each lens element of the array of lens elements may be positioned proximate one of each of the light emitting diodes of the array of light emitting devices. In one embodiment the axis of the lens elements are substantially coaxial with the axis of the solid-state light-emitting device and the apex of each of the conical elements is mounted spaced away from the solid-state light-emitting device by the substantially conical element of the lens. In another embodiment of the invention the inventors contemplate that the array of lens elements may comprise a plurality of lenslets. In still a further embodiment, either including lenslets or not including lenslets, each of the lens elements emits light sourced from the solid-state light-emitting devices in a pattern of fifty to eighty degrees from the axis of the conical shaped light-transmitting element. The solid-state light-emitting device mentioned above may be a light emitting diode.

Another embodiment of the luminaire will be a luminaire with a horizontal axis and a light emitting diode providing a source of light. A lens is positioned proximate the light emitting diode. This lens has a conical portion aligned substantially coextensively with the light emitted from the light emitting diode and delivers light in a pattern substantially non-parallel to the horizontal axis of the luminaire.

In further summary, an embodiment may include a planar structure comprising an array of solid-state light-emitting devices arranged on a first side of the planar structure, a lens sheet attached to the first side of the planar structure, multiple conically shaped projections carried on the lens sheet, and an alignment fixture positioned between the planar surface and the lens sheet. This allows the conically shaped projections carried on the lens sheet to be in alignment with the array of solid-state light emitting devices on the first side of the planar sheet. In this embodiment the multiple conically shaped projections may be splitting prisms.

In another embodiment of the device set forth above the lens sheet may be positioned proximate the array of solid-state light-emitting devices and generally parallel to the planar structure of the solid-state light-emitting devices. Or in another embodiment the lens sheet is positioned proximate the array of solid-state light-emitting devices. In another embodiment the lens sheet may have a surface formed of a plurality of facets.

The disclosure also discloses a light emitting focusing lens comprising a prismatic structure that has a substantially conically shaped section with an outwardly flared section formed to emit light rays in a range of angles to the major axis of the conical section. The angles of the emitted light rays may range from fifty to eighty degrees. In one embodiment of a light emitting focusing lens a light emitting diode is the source of light and the conical section major axis is substantially concentrically aligned with light emitted from the light emitting diode. Furthermore, the light emitting diode may have an axis and the emitted light rays from the light emitting focusing lens is between fifty and eighty degrees as measured from the axis of the light emitting diode.

It is also one embodiment of the invention to provide a lens for use with a solid-state light-emitting device wherein the lens comprises a structure having a conical section directed to nadir. The conical section has an outwardly flared section and the lens further comprises a curved tip portion directing a portion of the light emitted from the lens in the direction of nadir. This curved tip portion can comprise a curved convex tip portion in one embodiment or a curved concave tip portion in another embodiment.

In further summary and commensurate with some of the claims presented in this application, one embodiment of the invention includes a lens body having a perimeter sidewall that may be flared outwardly. A bridging surface is integral with the perimeter sidewall that defines a cavity. The perimeter sidewall includes a standoff section extending from a base portion of the perimeter sidewall. This standoff section has substantially parallel interior and exterior surfaces extending partway up the perimeter sidewall to a standoff section termination plane. A standoff section transition zone extends from the standoff section termination plane to the bridging surface of the lens body. In one embodiment an exterior curved lens surface is formed on an outer surface of the standoff section transition zone and an interior lens surface is formed on an inner surface of the standoff section transition zone. In another embodiment the standoff section transition zone has a curved section intermediate the standoff termination plane and the bridging surface of the lens body of a substantially uniform thickness. In such an embodiment the exterior curved lens surface and the interior lens surface have radii of lengths differing in length by the thickness of a curved section of the standoff section transition zone. In a different embodiment the standoff section transition zone has a curved section intermediate the standoff termination plane and the bridging surface of the lens body of a non-uniform uniform thickness rather than a uniform thickness. In this alternative embodiment the exterior curved lens surface and the interior lens surface will have similar radii with the lengths of the radii differing by the thickness of the curved section of the standoff section transition zone. A refinement of this embodiment is one where the standoff section transition zone has a curved section intermediate the standoff termination plane and the bridging surface of the lens body of a substantially non-uniform thickness and the interior lens surface has a compound curve surface having convex and concave portions extending from the standoff termination plane to the interior of the bridging surface of the lens body.

Another embodiment of the invention set forth above includes a substantially conical shaped projection integral with the bridging surface of the lens body. This conical shaped projection has an axis from a base of the conical shaped projection to an apex of the conical shaped projection. In one embodiment the curved surface of the conical shaped projection has a single radius curve from the base of the projection to the upper portion of the projection. In an alternative embodiment the curved surface of the conical shaped projection has a blend of radii describing a curve from the base of the projection to the upper portion of the projection. In some situations contemplated by the inventors the curved surface comprises more than one curve adjacent at least one other curve, whereby multiple radius curves make up the curved surface of the projection.

It is also contemplated that, with respect to the embodiments set forth above, the curved surface of the projection may include a faceted surface having facets defining circumferential substantially planar bands formed on the projection.

The method disclosed herein may include controlling light from a solid-state light-emitting device, such as, but not limited to a light emitting diode, comprising the acts of positioning a lens proximate to a solid-state light-emitting device with the apex of the lens aligned with the solid-state light-emitting device. The lens provides total internal reflection of light rays emanating from the solid-state light-emitting device and refracts the reflected light rays through a lens. In one embodiment the lens is a conical lens. In one embodiment of this method the act of maximizing the intensity of light emitted from a light emitting diode is accomplished by providing a lens proximate the light emitting diode, this lens having a conical surface concentrating the transmission of light in a range of fifty to eighty degrees from the axis of the light emitting diode.

While the invention is described herein in terms of preferred embodiments and generally associated methods, the inventor contemplates that alterations and permutations of the preferred embodiments and methods will become apparent to those skilled in the art upon a reading of the specification and a study of the drawings.

Accordingly, neither the above description of preferred exemplary embodiments nor the abstract defines or constrains the invention. Rather, the claims variously define the invention. Each variation of the invention is limited only by the recited limitations of its respective claim, and equivalents thereof, without limitation by other terms not present in the claim.

What is claimed is:

1. A lens for use with a solid-state light-emitting device, the device having an axis, the lens comprising:
a substantially conically shaped light-transmitting element positioned proximate the solid-state light-emitting device, the light-transmitting element having a major axis substantially aligned with the axis of the solid-state light-emitting device;
a profile formed on the light-transmitting element culminating in an apex pointing away from the solid-state light-emitting device when the light-transmitting element is positioned proximate the solid-state light-emitting device, the apex substantially coaxial with the axis of the solid-state light-emitting device.

2. The invention in accordance with claim 1 wherein the conically shaped light-transmitting element comprises:
a base, an apex and a curved surface body extending from the base to the apex; and
a major axis passing from the base through the apex of the curved surface body.

3. The invention in accordance with claim 2 wherein light entering the conically shaped light-transmitting element exits the conically shaped light-transmitting element after the light is refracted at the curved surface body of the conically shaped light-transmitting element.

4. The invention in accordance with claim 3 wherein light exiting the conically shaped light-transmitting element exits from the refracting surface of the curved surface body at angles of between fifty degrees and eighty degrees from the major axis of the conically shaped light-transmitting element.

5. The invention in accordance with claim 1 wherein the conically shaped light-transmitting element comprises a surface for redirecting a maximum intensity of light emitted from the solid-state light-emitting device in a pattern of fifty to eighty degrees from the major axis of the curved surface body.

6. The invention in accordance with claim 1 wherein the conically shaped light-transmitting element is a splitting prism.

7. The invention in accordance with claim 1 wherein the solid-state light-emitting device is a light-emitting diode.

8. A luminaire comprising:
a planar surface;
the planar surface having an array of solid-state light-emitting devices carried thereon, each device having an axis;
an array of lens elements, the lens elements having a substantially conical element defining an axis from a base to an apex, one of each lens elements of the array of lens elements positioned proximate one of each of the light-emitting diodes of the array of light-emitting devices, with the axis of the lens elements substantially coaxial with the axis of the solid-state light-emitting device; and
the apex of each of the conical elements is mounted spaced away from the solid-state light-emitting device by the substantially conical element of the lens.

9. The invention in accordance with claim 8 wherein the array of lens elements comprises a plurality of lenslets.

10. The invention in accordance with claim 8 wherein each of the lens elements emits light sourced from the solid-state light-emitting devices in a pattern of fifty to eighty degrees from the axis of the conical shaped light-transmitting element.

11. The invention in accordance with claim 8 wherein the solid-state light-emitting device is a light-emitting diode.

12. A planar structure comprising:
an array of solid-state light-emitting devices arranged on a first side of the planar structure, and
a lens sheet attached to the first side of the planar structure,
multiple conically shaped projections carried on the lens sheet,
an alignment fixture positioned between the planar surface and the lens sheet whereby the conically shaped projections carried on the lens sheet are in alignment with the array of solid-state light-emitting devices on the first side of the planar sheet.

13. The invention in accordance with claim 12 wherein the multiple conically shaped projections splitting prisms.

14. The invention in accordance with claim 12 further comprising the lens sheet positioned proximate the array of solid-state light-emitting devices and generally parallel to the planar structure of the solid-state light-emitting devices.

15. The invention in accordance with claim 12 further comprising the lens sheet positioned proximate the array of solid-state light-emitting devices, the lens sheet having a surface presenting a curved surface on the lens sheet between each solid-state light-emitting device of the array of solid-state light-emitting devices and the lenses formed on the lens sheet wherein the curved surface is formed of a plurality of facets.

16. A light-emitting focusing lens comprising a prismatic structure having a substantially conically shaped section with an outwardly flared section formed to emit light rays in a range of angles to the major axis of the conical section of from fifty to eighty degrees.

17. The invention in accordance with claim 16 further comprising a light-emitting diode as the source of light and the conical section major axis is substantially concentrically aligned with light emitted from the light-emitting diode.

18. The invention in accordance with claim 17 further comprising the light-emitting diode having an axis and the emitted light rays from the light-emitting focusing lens is between fifty and eighty degrees as measured from the axis of the light-emitting diode.

19. A lens used with a solid-state light-emitting device, the lens comprising a structure having a conical section directed to nadir with an outwardly flared section, the lens further comprising a curved tip portion directing a portion of the light emitted from the lens in the direction of nadir.

20. The invention in accordance with claim 19 wherein the curved tip portion comprises a curved convex tip portion.

21. The invention in accordance with claim 19 wherein the curved tip portion comprises a curved concave tip portion.

22. A luminaire having a horizontal axis, the luminaire comprising:
a light-emitting diode providing a source of light;
a lens positioned proximate the light-emitting diode, the lens having a conical portion aligned substantially coextensively with the light emitted from the light-emitting diode, the lens delivering light in a pattern substantially non-parallel to the horizontal axis of the luminaire.

23. A lens comprising:
a lens body having a perimeter sidewall;
a bridging surface integral with the perimeter sidewall.

24. The invention in accordance with claim 23 wherein the perimeter sidewall of the lens body is flared outwardly.

25. The invention in accordance with claim 23 further comprising:
a cavity defined by the perimeter sidewall;
a standoff section of the perimeter sidewall extending from a base portion of the perimeter sidewall, the standoff section having substantially parallel interior and exterior surfaces extending partway up the primeter sidewall to a standoff section termination plane;
a standoff section transition zone extending from the standoff section termination plane to the bridging surface of the lens body;
an exterior curved lens surface formed on an outer surface of the standoff section transition zone; and
an interior lens surface formed on an inner surface of the standoff section transition zone.

26. The invention in accordance with claim 25 comprising:
the standoff section transition zone having a curved section intermediate the standoff termination plane and the bridging surface of the lens body of a substantially uniform thickness;
the exterior curved lens surface and the interior lens surface having radii of lengths differing in length by the thickness of the curved section of the standoff section transition zone.

27. The invention in accordance with claim 25 comprising:
the standoff section transition zone having a curved section intermediate the standoff termination plane and the bridging surface of the lens body of a non-uniform uniform thickness;
the exterior curved lens surface and the interior lens surface having similar radii with the lengths of the radii differing by the thickness of the curved section of the standoff section transition zone.

28. The invention in accordance with claim 25 comprising:
the standoff section transition zone having a curved section intermediate the standoff termination plane and the bridging surface of the lens body of a substantially non-uniform thickness;
the interior lens surface having a compound curve surface having convex and concave portions extending from the standoff termination plane to the interior of the bridging surface of the lens body.

29. The invention in accordance with claim 23 further comprising a substantially conical shaped projection integral with the bridging surface of the lens body, the conical shaped projection having an axis from a base of the conical shaped projection to an apex of the conical shaped projection.

30. The invention in accordance with claim 29 wherein the curved surface of the conical shaped projection has a single radius curve from the base of the projection to the upper portion of the projection.

31. The invention in accordance with claim 29 wherein the curved surface of the conical shaped projection has a blend of radii describing a curve from the base of the projection to the upper portion of the projection.

32. The invention in accordance with claim 29 wherein the curved surface comprises more than one curve adjacent at least one other curve, whereby multiple radius curves make up the curved surface of the projection.

33. The invention in accordance with claim 29 wherein the curved surface of the projection comprises a faceted surface having facets defining circumferential substantially planar bands formed on the projection.

34. A method of controlling light from a solid-state light-emitting device comprising the acts of:
positioning a lens proximate to a solid-state light-emitting device with the apex of the lens aligned with the solid-state light-emitting device;
the lens providing total internal reflection of light rays emanating from the solid-state light-emitting device;
refracting the reflected light rays through the lens.

35. The method set forth in claim 34 wherein the lens comprises a conical lens.

36. The method set forth in claim 34 wherein the solid-state light-emitting device comprises a light-emitting diode.

37. The method set forth in claim 36 further comprising the act of maximizing the intensity of light emitted from a light-emitting diode by providing a lens proximate the light-emitting diode, the lens having a conical surface concentrating the transmission of light in a range of fifty to eighty degrees from the axis of the light-emitting diode.
